(19) United States
(12) Patent Application Publication
(10) Pub. No.: US 2021/0080084 A1
(43) Pub. Date: Mar. 18, 2021

(54) LIGHTING MODULE HAVING INTEGRATED ELECTRICAL CONNECTOR

(71) Applicants: Michael D. Danesh, Carson, CA (US); Benjamin Pin-Chun CHEN, Lomita, CA (US)

(72) Inventors: Michael D. Danesh, Carson, CA (US); Benjamin Pin-Chun CHEN, Lomita, CA (US)

(21) Appl. No.: 17/099,650

(22) Filed: Nov. 16, 2020

Related U.S. Application Data
(63) Continuation of application No. PCT/US2019/032281, filed on May 14, 2019.
(60) Provisional application No. 62/671,372, filed on May 14, 2018.

(51) Int. Cl. F21V 17/00; F21V 23/00; F21V 17/16; F21V 29/77; F21V 21/04

(52) U.S. Cl. CPC F21V 17/002; F21V 23/003; F21V 17/164; F21Y 2115/10; F21V 21/048; F21V 23/009; F21V 29/773

(57) ABSTRACT

A lighting module includes a housing formed of a thermally conducting material having a thermal conductivity greater than at least 0.5 W·m⁻¹K⁻¹. The housing comprises a sidewall that forms a substantially cylindrical cavity, and a flange surrounding an opening of the substantially cylindrical cavity. The lighting module includes at least one integrated electrical connector, mechanically engaged with and substantially lodged within at least a portion of the housing, to receive AC voltage from an electrical system of a building. The lighting module further includes a light source including at least one LED disposed in the substantially cylindrical cavity, and an AC to DC converter, disposed in the substantially cylindrical cavity, to receive electrical energy from the at least one integrated electrical connector and supply regulated electrical energy to power the light source.

### CROSS-REFERENCE TO RELATED PATENT APPLICATION(S)

The present application is a Bypass Continuation Application of International PCT Application PCT/US2019/032281, filed May 14, 2019, entitled “LIGHTING MODULE HAVING INTEGRATED ELECTRICAL CONNECTOR,” which claims priority to U.S. Provisional Application No. 62/671,372, filed on May 14, 2018, entitled “LIGHTING FIXTURE.” Each of the aforementioned applications is incorporated by reference herein in its entirety.

### BACKGROUND

A lighting fixture is a ubiquitous device that provides artificial lighting in various indoor and outdoor settings. Conventional lighting fixtures reliant on incandescent or compact fluorescent lamp (CFL) lighting have typically used replaceable bulbs where the bulb contains the components to receive an electrical input and to emit light. More recently, light emitting diode (LED)-based lighting fixtures have utilized lighting modules that contain LEDs and corresponding driver electronics to manage and control electrical inputs received by the lighting fixture. The lighting module, which in some implementations may be in the form of a bulb, provides users a convenient form to install and/or replace light emitting components in a lighting fixture.

### SUMMARY

The Inventors, via previous innovative designs for lighting modules, have recognized and appreciated that a lighting module in which a light source and electronics are integrated within a single package generally simplifies the installation of the lighting module into a given lighting fixture. In one aspect, installation of such a lighting module into the lighting fixture is facilitated by using one of a variety of standard electrical connectors and/or coupling mechanisms. However, the Inventors have also recognized that conventional lighting modules are typically designed particularly for use with corresponding specific types of lighting fixtures (e.g., recessed lighting fixtures, surface mount lighting fixtures, floodlight fixtures, security lighting fixtures, outdoor fixtures such as pathway or garden lighting, tree lighting, step lighting, etc.), in which the type of lighting fixture may impose corresponding particular constraints on the lighting module (based on the lighting fixture configuration and/or application for which the lighting fixture is being used). For example, a conventional lighting module designed for a surface mount lighting fixture may not fit into a recessed lighting fixture.

As a result, a conventional lighting module designed for use with a particular type of lighting fixture may be unsuitable for use with other types of lighting fixtures. Additionally, if a user wishes to change some aspect of the lighting fixture (e.g., the light output), a different lighting module may be required. Accordingly, multiple types of lighting modules may be required to accommodate different types of lighting fixtures and the user's desired specifications in a given environment (e.g., an office, a house, a multifamily residential building) leading to higher costs and maintenance.

The present disclosure is thus directed to various inventive implementations of “universal” lighting modules that are compatible with a variety of different types of lighting fixtures (e.g., in terms of one or more of form factor, size, electrical connection requirements), and are particularly well-suited for easy installation and replacement by those who are not experienced electrical contractors or lighting designers (e.g., homeowners, do-it-yourself enthusiasts, etc.). In one aspect, the lighting modules described herein may have a sufficiently compact form factor that enables the lighting module to fit into various types of lighting fixtures or other containers/enclosures for the lighting module; examples of such containers/enclosures or lighting fixtures include, but not limited to, various types of electrical junction boxes, a recessed lighting fixture (e.g., a “can” housing of a recessed lighting fixture), a surface mount lighting fixture, a pendant lighting fixture, a floodlight fixture, an outdoor lighting fixture (e.g., a tree lighting fixture, a step lighting fixture, a ground or pathway lighting fixture, a garden lighting fixture), and a security lighting fixture.

In other aspects of a relatively compact design for the various lighting modules disclosed herein, the housing for the lighting module may be a single or multi-piece construction (e.g., a main housing body mechanically coupled to a back cover or back cap for the main housing body), and some portion of the housing may be configured to include therein an integrated electrical connector, mechanically engaged with at least a portion of the housing, to facilitate a compact profile for the lighting module. In various respects, an integrated electrical connector provides a more finished and “clean” look to the lighting module and mitigates the need for wires loosely hanging out of the lighting module; this in turn can make installation and replacement less intimidating to homeowners or do-it-yourself enthusiasts who may have little to no experience with electrical or lighting systems.

Thus, various inventive lighting modules described herein may be “universal” in that a given lighting module may be employed in different types of lighting fixtures used for different lighting applications (e.g., the lighting module may be interchangeable between different lighting fixtures in a given environment, thus simplifying maintenance. For example, the inventive lighting modules described herein may be installed in different types of electrical junction boxes, recessed can housings for a recessed lighting fixture, a garden or pathway lighting fixture, a tree lighting fixture, a pendant lighting fixtures, a decorative lighting fixture, a step lighting fixture, and a floodlight fixture. In some implementations, the lighting module can include a plurality of mounting holes configured to align with corresponding holes for a particular size of an electrical junction box. To install the lighting module into different-sized junction boxes or other contains/enclosures or lighting fixtures, in some implementations a lighting module may be used together with a coupling adapter to facilitate installation of the lighting module into different size apertures of a container/enclosure or lighting fixture. In one example, such a coupling adapter may include holes configured to align with both the junction box and the lighting module.

In various implementations, the inventive lighting modules described herein can be readily coupled to a trim in a variety of manners. For example, a given lighting module can couple to a trim with retaining springs, which can secure both the lighting module and the trim to a recessed can housing, for example. To install the lighting module into different-sized lighting fixtures, trims with various retaining springs can be used. In some implementations, a trim coupled to a lighting module significantly facilitates the dissipation of heat generated by the lighting module (e.g., heat generated by the light sources and/or driver/power electronics in the lighting module).

In some implementations, the module housing of the lighting module can also be used to enclose only a light source and a driver. To improve light output from the lighting module, optical elements can be disposed on each light source to couple more light into the surrounding air, the interior sidewalls of the module housing can be coated with a reflective coating to reduce parasitic absorption losses, and the cover lens can redirect light to a desired angular and spatial distribution. In this manner, in some lighting module examples, a separate reflective element does not need to be included, which can allow for a smaller form factor lighting module and reduce costs for manufacture and assembly.

In other implementations, a diffused lens or a clear lens with a diffuser can be utilized to protect the light source and provide more uniform illumination across the lens. In yet other implementations, a light guide can be utilized, wherein the light source is mounted on a sidewall of the housing of the lighting module to decrease the dimension of the module.

In sum, one example implementation is directed to a lighting module, comprising: a housing formed of a thermally conducting material having a thermal conductivity greater than at least 0.5 W·m⁻¹K⁻¹, the housing comprising a sidewall forming at least one substantially cylindrical cavity and comprising a flange surrounding an opening of the substantially cylindrical cavity; at least one integrated electrical connector, mechanically engaged with and substantially lodged within at least a portion of the housing, to receive AC voltage from an electrical system of a building; a light source including at least one LED disposed in the substantially cylindrical cavity; and an AC to DC converter, disposed in the substantially cylindrical cavity, to receive electrical energy from the at least one integrated electrical connector and supply regulated electrical energy to power the light source.

U.S. Pat. No. 9,964,266, issued May 8, 2018 and entitled “Unified Driver and Light Source Assembly for Recessed Lighting,” is incorporated by reference herein in its entirety.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a front perspective view of a lighting module, according to some implementations.

FIG. 1B is a rear perspective view of the lighting module shown in FIG. 1A where the back cover is separated from the module housing.

FIG. 1C is a side view of the lighting module shown in FIG. 1A where the back cover is removed.

FIG. 1D is a front perspective cross-sectional view of the lighting module shown in FIG. 1A.

FIG. 1E is a side cross-sectional view of the lighting module shown in FIG. 1A.

FIG. 1F is an exploded view of the lighting module shown in FIG. 1A.

FIG. 2 is a rear perspective view of a lighting module with no fins along the sidewall, according to some implementations.

FIG. 3A is front view of a light source and driver disposed inside a module housing, according to some implementations.

FIG. 3B is an illustration detailing an arrangement of light sources and driver electronics on a single board disposed inside a module housing, according to some implementations.

FIG. 3C is an illustration detailing an arrangement of light sources and driver electronics on separate boards disposed inside a module housing, according to some implementations.

FIG. 4A is an image of exemplary junction boxes that are compatible with the various implementations of the lighting module disclosed herein.

FIG. 4B is a front perspective view of a lighting module with a twist-and-lock connector, according to some implementations.

FIG. 4C is a rear view of the lighting module shown in FIG. 4B.

FIG. 4D is a front view of the lighting module shown in FIG. 4B.

FIG. 4E is a side cross-sectional view of the cross section A-A shown in FIG. 4D.

FIG. 4F is a side cross-sectional view of the cross section B-B shown in FIG. 4D.

FIG. 4G is a rear perspective view of a lighting module disposed into a junction box and coupled to a trim, according to some implementations.

FIG. 4H is a front view of an adapter, according to some implementations.

FIG. 4I is an illustration showing the assembly of a lighting module 100 in a 4 inch junction box using an adapter, according to some implementations.

FIG. 5A is an illustration detailing the assembly of the lighting module and the trim into a junction box mounted to a surface, according to some implementations.

FIG. 5B is an illustration of the assembled lighting module shown in FIG. 4C installed in the junction box mounted to the surface.

FIG. 5C is a rear perspective view of a lighting module coupled to a trim with a retaining spring, according to some implementations.

FIG. 5D is a side cross-sectional view of the lighting module shown in FIG. 7A.

FIG. 5E is the side cross-sectional view of FIG. 7B where the lighting module and the trim are transparent.

FIG. 6A is an exemplary trim with a retaining spring where the front surface of the lighting module is approximately coplanar with the front surface of the trim, according to some implementations.

FIG. 6B is an exemplary trim with a retaining spring where the front surface of the lighting module is positioned inside a cylindrically recessed cavity, according to some implementations.

FIG. 6C is an exemplary trim with a retaining spring where the front surface of the lighting module is positioned inside a conically recessed cavity, according to some implementations.

FIG. 7A is an exemplary trim with a twist-and-lock connector where the front surface of the lighting module is approximately coplanar with the front surface of the trim, according to some implementations.

FIG. 7B is an exemplary trim with a twist-and-lock connector where the front surface of the lighting module is positioned inside a cylindrically recessed cavity, according to some implementations.

FIG. 7C is an exemplary trim with a twist-and-lock connector where the front surface of the lighting module is positioned inside a conically recessed cavity, according to some implementations.

FIG. 8A is a side view of a lighting module with both a twist-and-lock connector and a snap-in connector, according to some implementations.

FIG. 8B is a side view of a lighting module with a snap-in connector, according to some implementations.

FIG. 8C is a side view of a lighting module with a twist-and-lock connector that is not coplanar with the front-most surface of the lighting module, according to some implementations.

FIG. 8D is a side view of a lighting module with a twist-and-lock connector that is coplanar with the front-most surface of the lighting module, according to some implementations.

FIG. 9A shows a bottom, perspective view of an exemplary lighting module.

FIG. 9B shows an exploded view of the lighting module of FIG. 9A.

FIG. 9C shows a cross-sectional side view of the lighting module of FIG. 9A.

FIG. 10A shows side view of an exemplary module housing formed using a base and an overmold.

FIG. 10B shows a bottom, perspective view of the module housing of FIG. 10A.

FIG. 11 shows an exemplary optic mounted to a retaining ring.

FIG. 12 shows an exemplary lighting module coupled to a trim.

FIG. 13 shows an exemplary light source and optic that couples light into the ambient environment.

FIG. 14A shows a bottom view of an exemplary lighting module with a circular cavity with a sidewall along which the light source is disposed.

FIG. 14B shows a bottom, perspective view of the lighting module of FIG. 14A.

FIGS. 15A, 15B and 15C show respective side, bottom, and perspective views of a recessed lighting fixture including a lighting module according to the various implementations illustrated and described herein.

FIGS. 16A, 16B and 16C show respective side, bottom, and perspective views of a lighting module according to the various implementations illustrated and described herein, disposed in a junction box and coupled to a surface mount trim in a surface mount lighting configuration.

FIGS. 17A, 17B and 17C show respective front, side, and perspective views of a lighting module according to the various implementations illustrated and described herein, disposed in a junction box and coupled to a step light trim in a step light configuration.

FIGS. 18A, 18B and 18C illustrate a lighting module according to the various implementations illustrated and described herein, disposed in a tree lighting fixture, a pathway lighting fixture, and a flood lighting fixture, respectively.

### DETAILED DESCRIPTION

Following below are more detailed descriptions of various concepts related to, and implementations of, lighting modules that may be readily used with a variety of different containers/enclosures or different types of lighting fixtures in both indoor and outdoor environments. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive lighting modules are provided, wherein a given example or set of examples showcases one or more particular features of a lighting module. It should be appreciated that one or more features discussed in connection with a given example of a lighting module may be employed in other examples of lighting modules according to the present disclosure, such that the various features disclosed herein may be readily combined in a given lighting module according to the present disclosure (provided that respective features are not mutually inconsistent).

### First Examples of a Lighting Module with an Integrated Electrical Connector

In a first set of examples presented below, lighting modules are disclosed that include one or more of the following features: an electrical connector integrated in a housing of the lighting module (or a back cover/cap of the housing); LED light sources arranged proximate to an interior sidewall of the housing of the lighting module (e.g., in a substantially circular configuration) and positioned so as to back-light an optic (e.g., lens) of the lighting module; a lighting module housing with a snap fit connector configuration for mechanically coupling a trim to the lighting module (e.g., using a retaining spring); and a lighting module housing with a twist and lock connector configuration for mechanically coupling a trim to the lighting module.

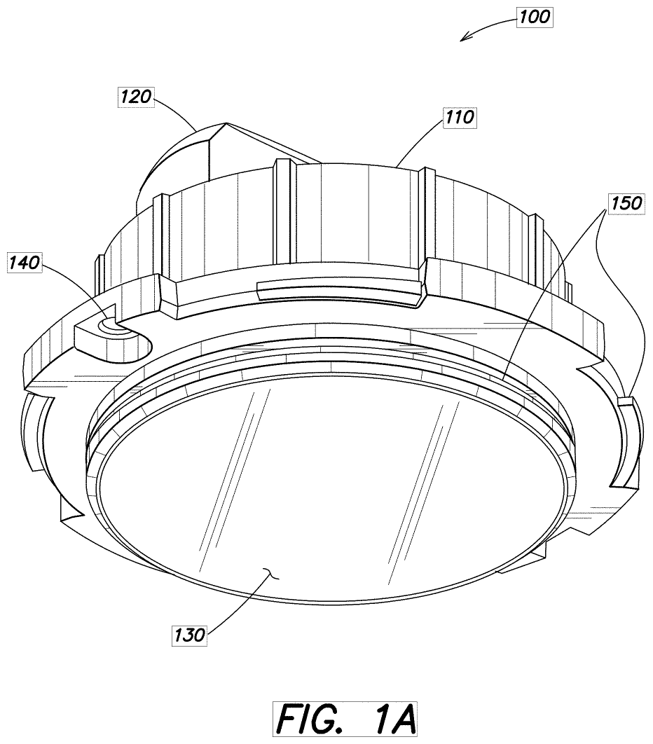

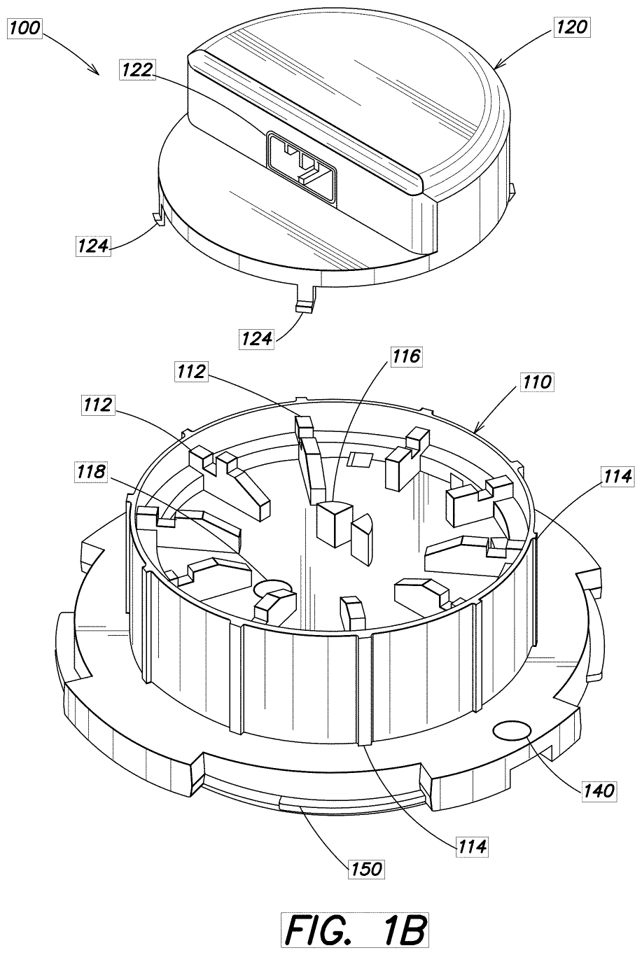

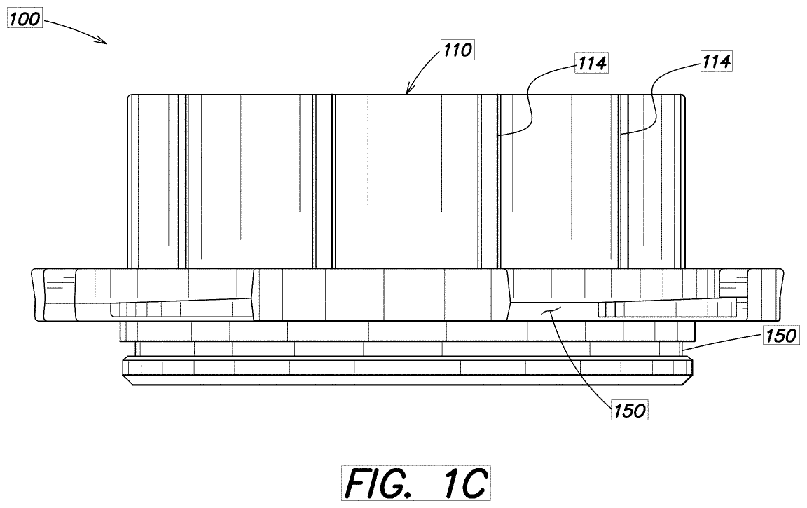

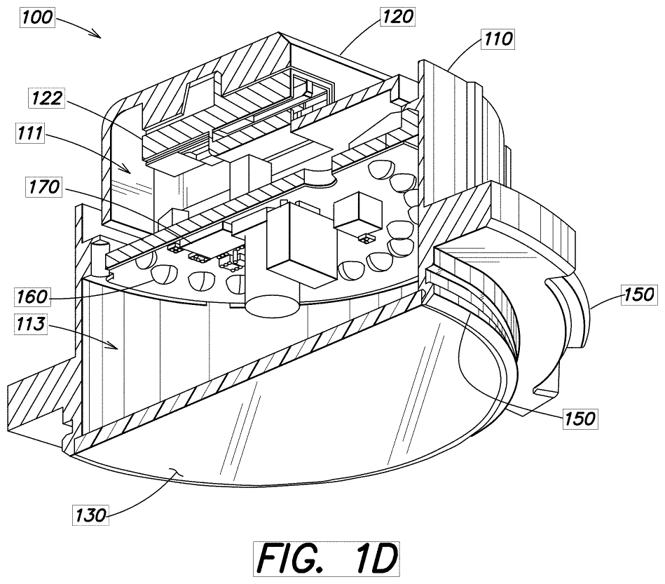

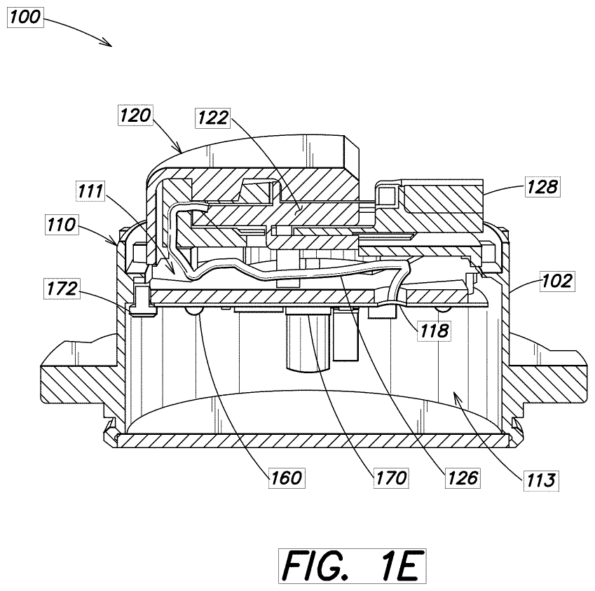

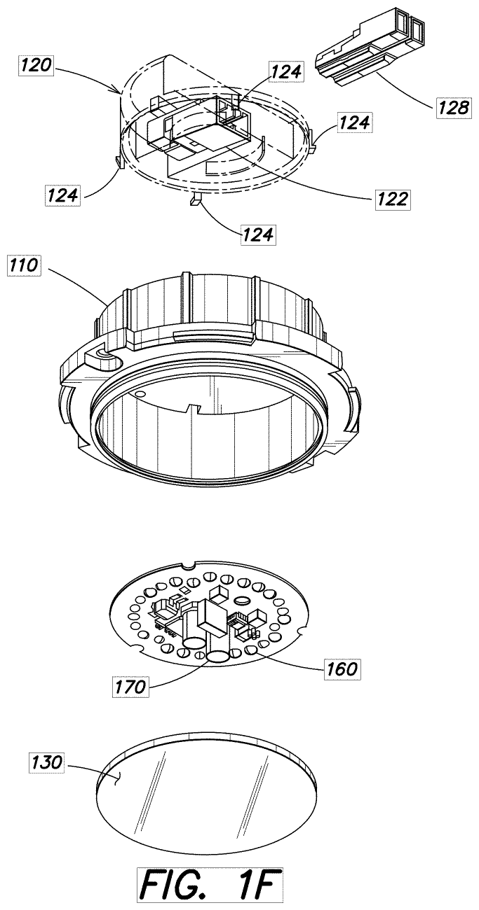

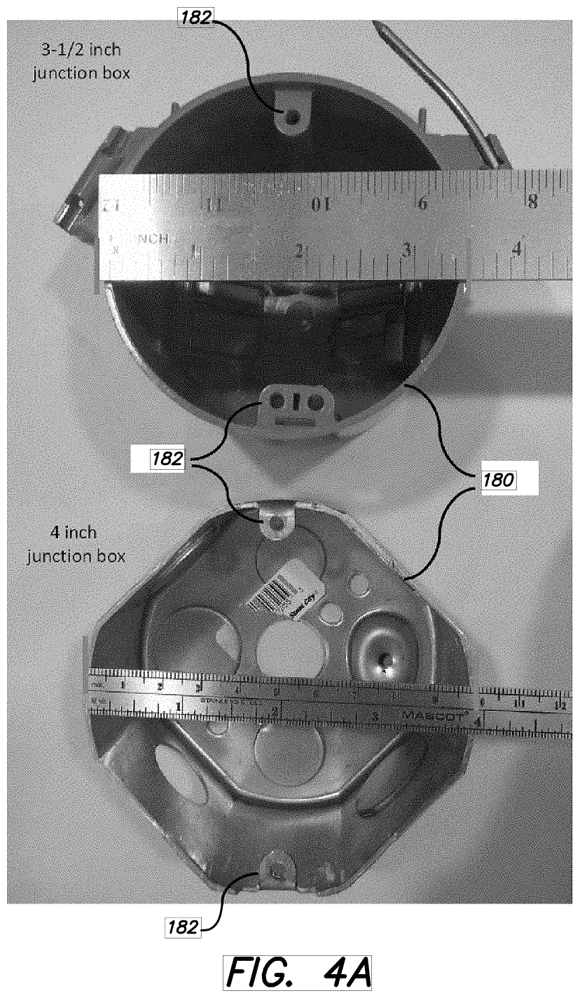

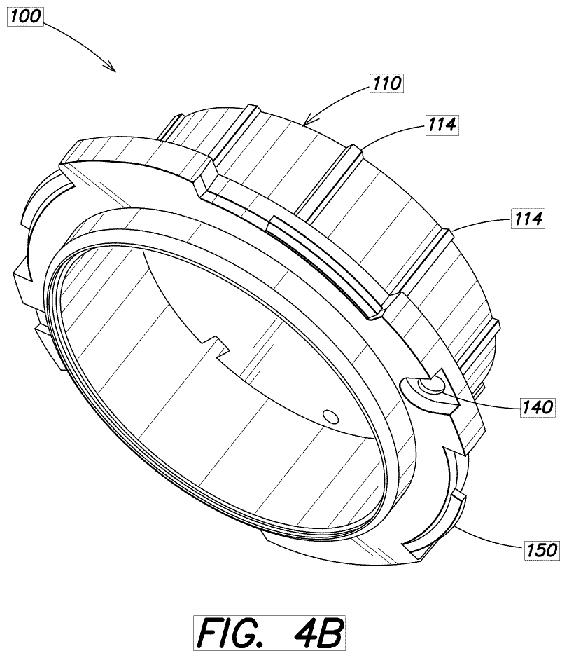

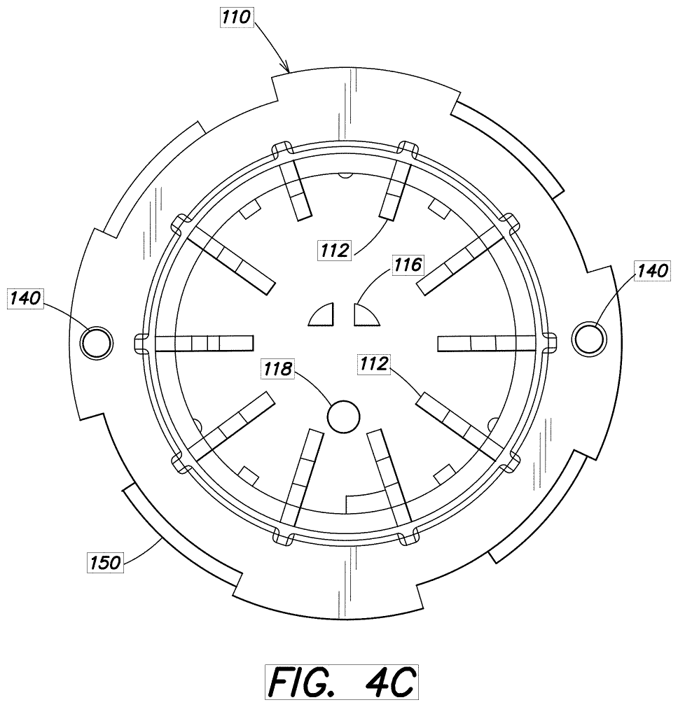

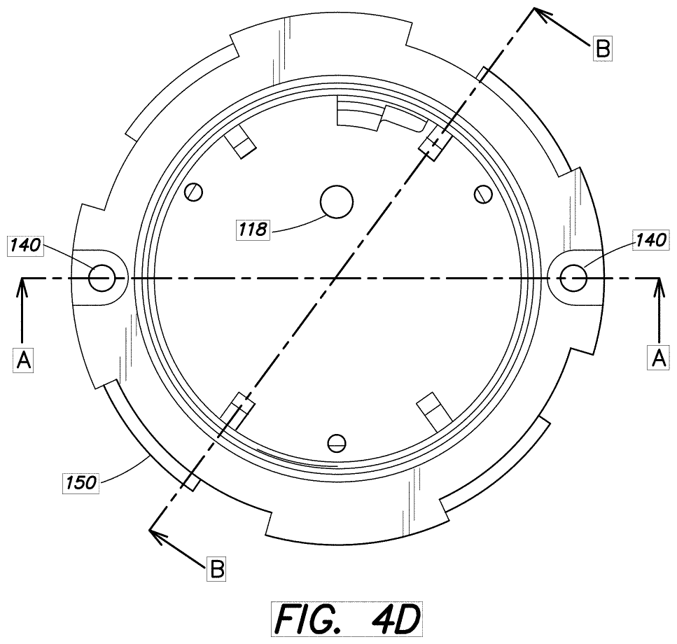

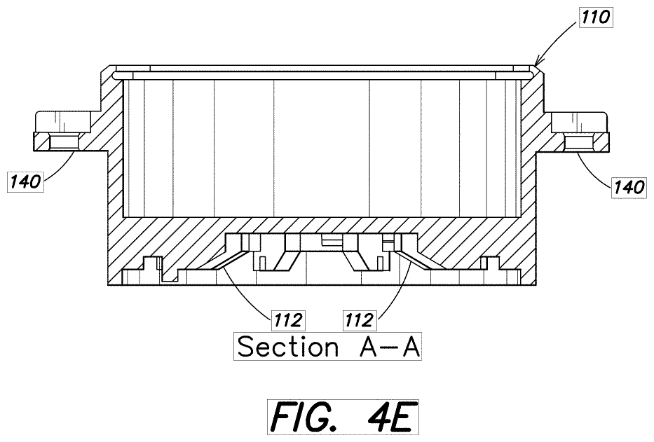

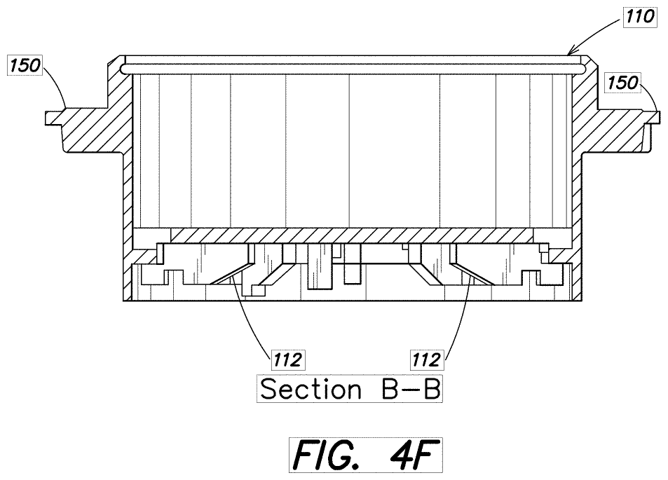

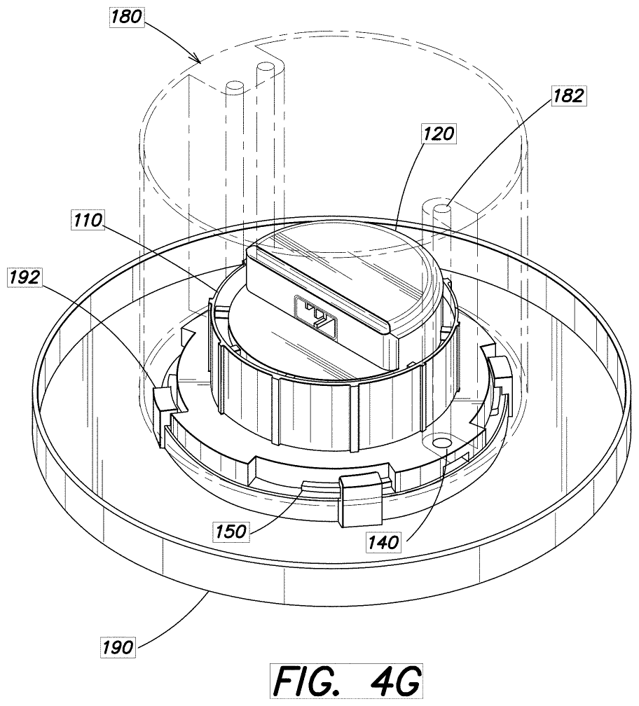

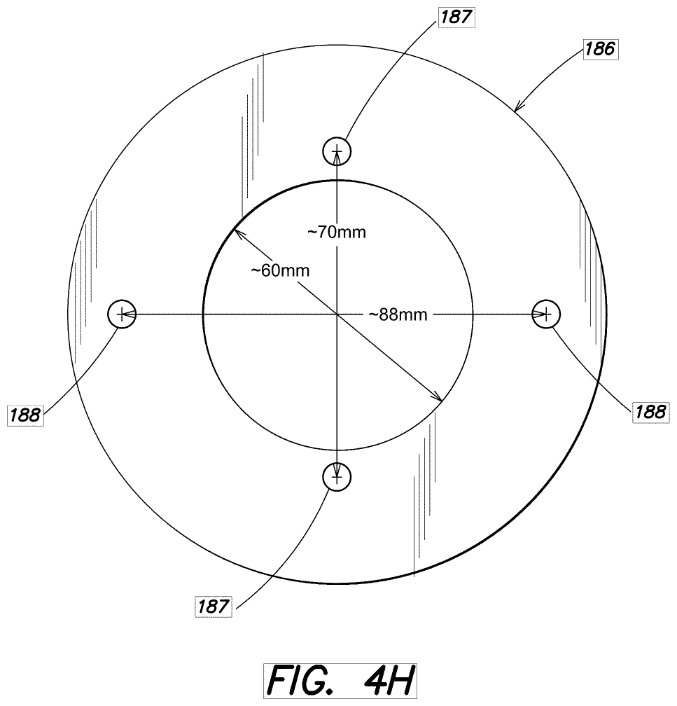

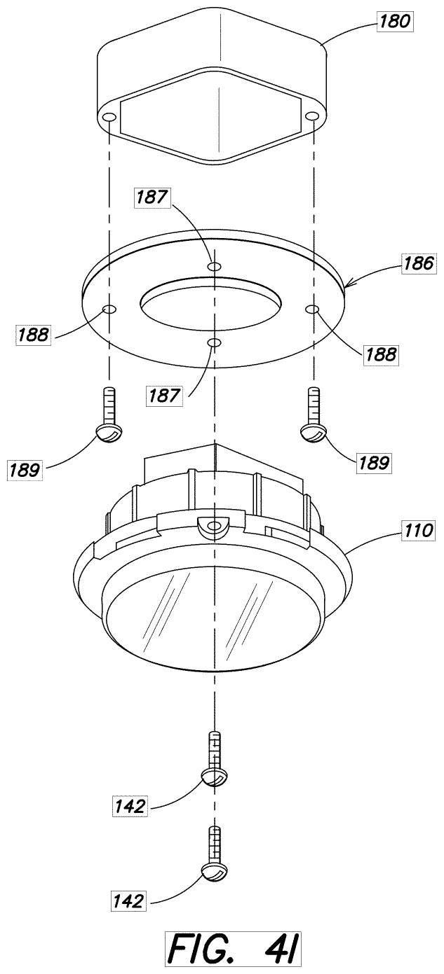

FIGS. 1A-1F show a first example implementation of a lighting module 100. The lighting module 100 may include a module housing 110 that encloses a light source 160 that emits light, and a driver 170 that supplies and regulates electricity to the light source 160. A back cover 120 may be coupled to the rear surface of a partition 104 of the module housing 110 and may include an integrated electrical connector 122, mechanically engaged with the back cover, to improve ease of installation when connecting the lighting module 100 to an external power source (e.g., an AC voltage from an electrical system of a building in which a lighting fixture containing the lighting module is installed). A cover lens 130 may be coupled to the front end of the module housing 110 to distribute light into a surrounding environment. In some implementations, the lens 130 may substantially separate the light source 160 and driver 170 from the surrounding environment. The module housing 110 may include various features, e.g., holes 140, that allow the lighting module 100 to couple to another structure, e.g., a junction box (see FIG. 4A) or lighting fixture having various configurations. The module housing 110 may also include one or more connecting members 150 configured to couple a trim 190 the lighting module.

As shown in FIGS. 1D and 1E, the module housing 110 may include a cavity 113 defined by a sidewall 102 and containing the light source 160 and the driver 170. In some implementations, the length of the sidewall 102 (e.g., along a vertical direction in FIG. 1E) may depend on the dimensions of the driver 170 and/or the desired thermal performance to dissipate heat away from the electronics associated with the light source 160 and/or the driver 170.

The back cover 120 may be used to house, at least in part, and/or mechanically support, the electrical connector 122 and to enclose a plurality of wires 126 that couples the electrical connector 122 to the driver 170. The electrical connector 122 may be mechanically engaged with the back cover such that it is substantially lodged within the back cover in a fixed position (e.g., via one or more snap-fit or push-to-fit tabs) in a formed compartment of the back cover. As shown in FIGS. 1B, 1D and 1F, in one aspect an accessible end of the electrical connector, once engaged with and lodged within the formed compartment of the back cover, is essentially flush with an exterior surface of the back cover, such that the electrical connector does not substantially protrude from the back cover. In another aspect, the electrical connector may be of a “quick connector” type that remains in place within the compartment of the back cover and is configured such that a corresponding mating electrical connector 128 (shown in FIGS. 1E and 1F) coupled to an external power source may be plugged into the electrical connector 122 to provide electrical power to the lighting module 100 (e.g., via an AC power source, such as the electrical system of a building). In this manner, the back cover 120 may be used to at least partially shield internal wiring in the lighting module 100 from the surrounding environment and to improve ease of installation. Furthermore, in some respects, an electrical connector thusly integrated with the back cover (or another portion of the housing) provides a more finished and “clean” look to the lighting module and mitigates the need for wires loosely hanging out of the lighting module; this in turn can make installation and replacement less intimidating to homeowners or do-it-yourself enthusiasts who may have little to no experience with electrical or lighting systems. Examples of an electrical connector that may be employed as the electrical connector 122 include, but are not limited to, the Ideal Powerplug® luminaire disconnect model 182 series connectors.

In other examples discussed further below, the light source 160 and the driver 170 are on separate substrates, and the driver may be included in a back cover or an alternative back cavity of the housing. In one aspect of this alternative design, the driver electronics are placed in the housing at a greater distance from the light source, thereby reducing exposure of the driver electronics to heat generated by the light source (and vice versa).

In some implementations, as shown in FIGS. 1B and 1F, the back cover 120 may be a separate component coupled to a rear exterior surface of the module housing 110 via a plurality of connecting members 124 to facilitate ease of alignment and assembly. The connecting members 124 may be various types of connectors, including, but not limited to snap fit connectors, screw fasteners, adhesive, thermal paste, and tape. The type of connecting member 124 may also vary depending on the compliance of the material used to form the back cover 120. For example, FIG. 1B shows an implementation where the connecting members 124 are a plurality of snap fit connectors configured to couple to a corresponding plurality of holes on the rear exterior surface of the module housing 110. In the implementation shown in FIG. 1B, the back cover 120 may be formed from a sufficiently flexible material to allow the snap fit connectors to bend in order to fit into the holes on the module housing 110.

The back cover 120 may be formed from a variety of plastics and metals, including, but not limited to, aluminum, steel, stainless steel, polyethylene, polyethylene terephthalate, polyvinyl chloride, polypropylene, and polystyrene. Depending on the materials used to form the back cover 120, a variety of manufacturing methods can be used to fabricate the back cover 120 including, but not limited to, injection molding, milling, polishing, lapping, grinding, or any other method known to one of ordinary skill in the art.

The assembly of the back cover 120 to the module housing 110 defines a back cavity 111 disposed, in part, within a backside section 105 of the module housing 110 that partially encloses the electrical connector 122 and a plurality of wires 126 used to electrically couple the electrical connector 122 to the driver 170. In some implementations, the back cavity 111 may be partially defined by a plurality of rear fins 112 disposed on the rear exterior surface of the module housing 110. As shown in FIG. 1B, a slot may be incorporated onto each rear fin 112 and configured to receive a portion of a sidewall on the back cover 120. The size of the back cavity 111 may thus vary based on the depth of the slot on each rear fin 112 and the length of the sidewall of the back cover 120.

In some implementations, the back cover 120 and the rear exterior surface of the module housing 110 may be configured to form a substantially sealed back cavity 111 enclosing the plurality of wires 126. By forming a sealed cavity, the plurality of wires 126 can be sufficiently isolated from the surrounding environment such that a separate grounding wire does not need to be included in the lighting module 100 to satisfy various electric codes specified by the National Electrical Code (NEC) and the Underwriters Laboratories (UL). In some implementations, the back cover 120 can be positioned such that the back cavity 111 is partially exposed to the surrounding environment through openings formed between the back cover 120 and the module housing 110. The openings can provide a pathway for air to circulate from the back cavity 111 to the surrounding environment, which can improve heat convection from the rear exterior surface of the module housing 110.

The module housing 110 may include a feedthrough 118 that allows the plurality of wires 126 to be fed through from the rear exterior surface of the module housing 110 to the rear interior surface of the cavity defined by the module housing 110 such that a first end of the plurality of wires 126 can be coupled to the driver 170. In some implementations, the feedthrough 118 may be a hole disposed on the rear surface of the module housing 110, as shown in FIGS. 1B and 1D. In some implementations, the board supporting the driver 170 may also include a hole aligned to the feedthrough 118 to allow the plurality of wires 126 to connect to the front surface of the board where the driver electronics 170 are disposed. The second end of the plurality of wires 126 can be coupled to the electrical connector 122. The first end and the second end of the plurality of wires 126 can be coupled to the driver 170 and the electrical connector 122, respectively, using a variety of coupling mechanisms, including, but not limited to, solder bonding, terminal screws, and electrically conductive epoxy.

In some implementations, a strain relief feature 116 can be incorporated on the module housing 110 or the back cover 120 to relieve strain in the plurality of wires 126. For example, the strain relief feature 116 can mechanically couple to a portion of the wires 126 such that forces applied to the wires 126, e.g., during assembly, are not transferred to the first or second ends of the wires 126, where coupling to the driver 170 and the electrical connector 122 may be more fragile. For example, in some implementations, the strain relief feature 116 can be formed from a plurality of protruding features forming a slot dimensioned to be smaller than the diameter of the wires 126 on the exterior rear surface of the module housing 110, as shown in FIG. 1B and 1E. The wires 126 can be press fit into the slot to mechanically restrict the motion of the wires 126 due to friction between the strain relief feature 116 and the portion of the wires 126 in contact with the strain relief feature 116. In some implementations, the strain relief feature 116 can be a post or a rod configured such that the wires 126 can be tied to the strain relief feature 116 using an additional wire or zip tie. In some implementations, a plurality of strain relief features 116 can be disposed on both the back cover 120 and the module housing 110 to relieve strain along a plurality of positions along the wires 126.

The electrical connector 122 may be coupled to the back cover 120 using a variety of coupling mechanisms, including, but not limited to, a press fit, a snap fit, screw fasteners, adhesive, and tape. For example, FIGS. 1D and 1E shows an implementation where the electrical connector 122 is press fit into the back cover 120 such that a portion of the back cover 120 clamps the side of the electrical connector 122.

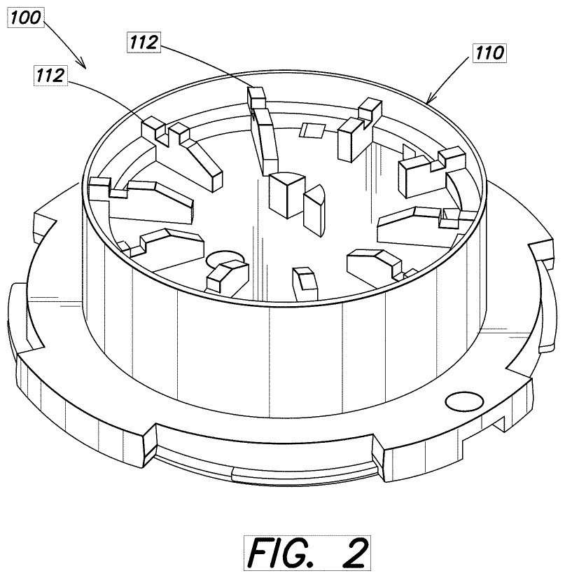

In some implementations, a plurality of rear fins 112 and/or side fins 114 may be disposed on the module housing 110 to improve heat dissipation to the surrounding air by increasing the surface area available for heat convection. For example, FIG. 1B shows an implementation for the lighting module 100 where the module housing 110 include both rear fins 112 on the rear exterior surface of the partition 104 and disposed within the backside section 105 and side fins 114 on an exterior surface of the sidewall 102. FIG. 2 shows another example implementation of a lighting module 100 where the module housing 110 only includes rear fins 112 and no side fins 114.

In some implementations, the module housing 110 may also dissipate heat, in part, through a trim 190 coupled to the lighting module 100. The trim 190 may be used to cover a hole in a wall or ceiling into (or onto) which the lighting fixture that houses the lighting module 100 is installed. The trim 190 may mechanically contact the sidewall 102 of the module housing 110 along the cavity 113. This contact may provide an interface through which heat generated by the light source 160 and/or the driver 170 may be transferred via heat conduction. The heat received by the trim 190 may then be transferred to other portions of the trim 190 or the building structure that are at ambient temperature. In this manner, the trim 190 may be used to maintain the lighting module 100, particularly the light source 160, at a desired operating temperature, thus increasing the lifetime of the lighting module 100 and/or satisfying electrical code standards while reducing the overall size of the lighting module 100.

The light source 160 may be various types of electro-optical devices including, but not limited to, a light emitting diode (LED), an organic light emitting diode (OLED), and a polymer light emitting diode (PLED). In some implementations, the light source 160 may include one or more light emitting elements, e.g. multiple LEDs, OLEDs, or PLEDs, to increase light output and/or to alter the spectral characteristics of light emitted into the surrounding environment. The driver 170 may include various electronics and circuitry used to supply and regulate electricity in order to power and control the light source 160, respectively. In some implementations, the driver comprises an AC to DC converter to receive electrical energy from an AC power source (e.g., the electrical system of a building), and supply regulated electrical energy to power the lighting module (e.g., in the form of a DC voltage and/or current).

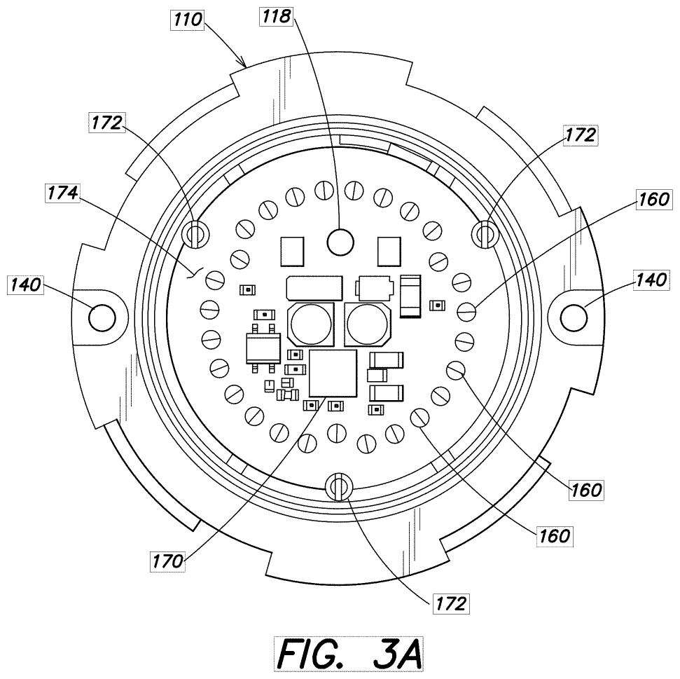

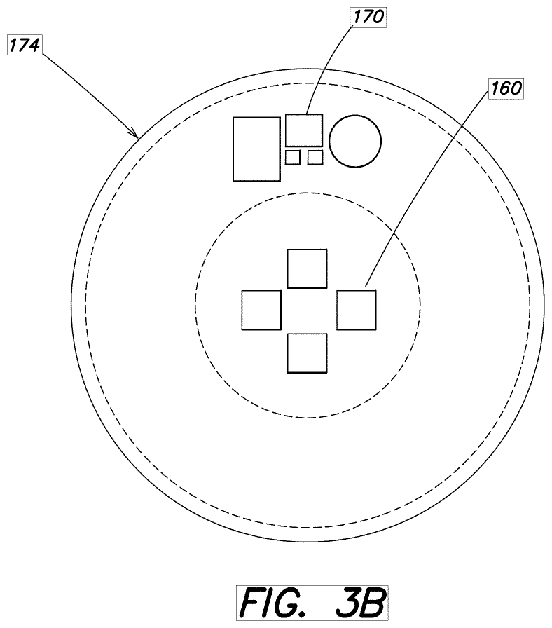

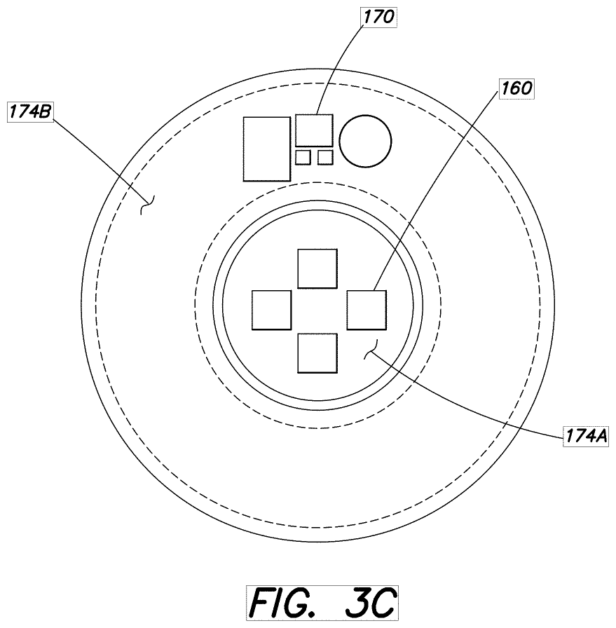

In some implementations, the light source 160 and the driver 170 may be disposed on a single board 174, e.g. a printed circuit board (PCB), as shown in FIGS. 3A and 3B, to simplify manufacture and assembly. In FIG. 3A, respective LEDs of the light source 160 are disposed in a circular arrangement proximate a perimeter of the board 174, whereas in FIG. 3B, multiple LEDs of the light source 160 are disposed generally in a center of the board 174. The board 174 may be dimensioned and shaped to fit inside the cavity defined by the module housing 110. In some implementations, the light source 160 and the driver 170 may be disposed onto two or more boards 174 and coupled electrically via additional wiring elements to provide greater design flexibility, particularly when the same driver 170 may be used for various types of light sources 160. In some implementations, the two or more boards 174 may be positioned to be approximately coplanar. For example, FIG. 3C shows one implementation where a plurality of light sources 160 are disposed on a first board 174A and the driver 170 is disposed on a second board 174B configured to surround the first board 174 concentrically. In some implementations, the board 174 may also include a hole aligned to the feedthrough 118 (e.g., see FIG. 3A) that allows wires 126 from the back cover 120 to pass through the board 174 and couple to the driver 170. The wires 126 may couple to the driver 170 using various connection mechanisms including, but not limited to, solder bonding, terminal screws, and electrically conductive epoxy.

In some implementations, the one or more boards 174 supporting the light source 160 and the driver 170 may be coupled to the rear or side interior surface of the cavity defined by the module housing 110 using various coupling mechanisms including, but not limited to, adhesives, screw fasteners, tapes, and clips. For example, FIG. 3A shows a single board 174 supporting light sources 160 and the driver 170 secured to the module housing using a plurality of connecting members 172, e.g., screw fasteners. Heat generated by the light source 160 may be dissipated into the module housing 110 via heat conduction through the supporting board 174. A thermally conductive epoxy, adhesive, or paste may be disposed between at least a portion of the board 174 supporting the light source 160 and the module housing 110 to further improve heat dissipation. In some implementations, the one or more boards 174 may be a flexible printed circuit, which may be mounted to the module housing 110 using a thermally conductive adhesive.

As noted above, in some implementations, one or more light sources 160 may be substantially disposed near the center of the rear interior surface in the cavity 113 defined by the module housing 110, as shown in FIGS. 3B and 3C. The electronics of the driver 170 may then be disposed along at least a portion of the periphery of the light sources 160, as shown in FIGS. 3B and 3C. In other implementations, the light source 160 may be disposed on a board 174 in an approximately circular arrangement around a perimeter of the board 174 (e.g., proximate to the sidewall 102 of the housing 110), as shown in FIG. 3A. In other implementations, the driver 170 may be disposed in a separate cavity in the module housing 110. By placing the light sources 160 near the center of the module housing 110, light emitted by the light sources 160 is less likely to be obstructed by the interior sidewalls of the module housing 110 or the driver electronics 170. In some implementations, the electronics of the driver 170 may instead be substantially disposed near the center of the rear interior surface in the cavity defined by the module housing 110. One or more light sources 160 may then be disposed along at least a portion of the periphery of the driver 170, as shown in FIG. 3A. This configuration may allow for more light sources 160 to be used due to a larger area available along the periphery of the driver 170. In some implementations, the light sources 160 may be interspersed with the driver electronics 170 and uniformly distributed along the rear interior surface of the cavity in the module housing 110.

The light source 160 may also include an optical element configured to increase the light output of the light source 160. In some implementations, the optical element may be a prism placed in contact with the light emitting element(s) of the light source 160. For example, the optical element can be formed from a material that is transparent and has a refractive index greater than 1 within the spectrum of light emitted by the light source 160. The optical element may be dimensioned and shaped to couple light from the light source 160 that would otherwise be trapped due to total internal reflection. As shown in FIGS. 1F and 3A, the optical element may be a dome-shaped optical element placed onto each light source 160.

The interior surfaces of the cavity 113 defined by the module housing 110 may be configured to reflect light emitted by the light sources 160 to increase the light output of the lighting module 100 into the surrounding environment. In some implementations, the interior surfaces of the cavity may be coated with a reflective coating to reduce parasitic absorption of light from the module housing 110. The reflective coating may be a paint that reflects light diffusely (e.g., a white matte paint), specularly (e.g., a mirror-finish paint), or some combination thereof. In some implementations, the reflective coating may also be applied using powder coating. Additionally, a reflective film or sheet may also be applied to the interior surfaces of the cavity 113. In this manner, a separate reflective element may be excluded from the lighting module 100, reducing the form factor of the lighting module 100 and costs for manufacture and assembly.

The cover lens 130 may also be configured to transmit light in a direct or diffuse manner. In some implementations, the cover lens 130 can be configured to have a high optical clarity such that the spatial and angular distribution of emitted light is dependent primarily on the light source 160 and the reflective characteristics of the sidewalls of the cavity in the module housing 110. In some implementations, the cover lens 130 can be textured or patterned to scatter light. For example, the cover lens 130 can diffusely scatter light to provide more uniform soft lighting in the environment. The cover lens 130 may be an optical element that modifies the spatial and angular distribution of light coupled into the surrounding environment. The cover lens 130 may be formed into various shapes. For example, the cover lens 130 can be substantially flat, as shown in FIGS. 1E and IF, or can be either convex or concave in shape, e.g., a dome-shaped cover lens 130. The thickness of the cover lens 130 can also vary spatially. For example, the cover lens 130 may be configured to have a convex surface where the center of the cover lens 130 is thicker than the periphery such that light emitted by the light source 160 is focused when coupled into the environment. In another example, the cover lens 130 can be configured to have a concave surface where the center of the cover lens 130 is thinner than the periphery to diverge light emitted by the light source 160. In other examples of lighting modules discussed further below, the cover lens may be be a PMMA light guide with hot embossed microstructures pressed into the surface. The microstructure features disperse the light out of the light guide in a controlled manner. A variety of patterns may be pressed onto the surface of the PMMA light guide to manipulate the light output beam spread, thereby allowing various beam patterns in a relatively shallower cavity.

In some implementations, the cover lens 130 may be coupled to the front surface of the module housing 110 such that the cover lens 130 is substantially flush with the front surface of the module housing 110. The cover lens 130 may be coupled to the module housing 110 using various connecting mechanisms including, but not limited to, adhesive, snap fits, clamps, and screw fasteners. In some implementations, the cover lens 130 and the module housing 110 can form a substantially sealed enclosure, which reduces the exposure of the driver 170 to the surrounding environment. By using the cover lens 130 to shield the driver 170 from the environment, potential fire risks and other hazards can be reduced, thus enabling the lighting module 100 to comply with fire codes specified by the National Electrical Code (NEC) and the Underwriters Laboratories UL).

The cover lens 130 can be formed from various optically transparent materials, e.g., glasses or polymers, including, but not limited to, polycarbonate, acrylic polymer, cyclo olefin polymer (Zeonex), polystyrene, silicate-based glasses, calcium fluoride, magnesium fluoride, silicon, germanium, or zinc selenide. Depending on the materials used to form the cover lens 130, various manufacturing methods can be used, including, but not limited to, injection molding, milling, polishing, lapping, grinding, hot embossing, or any other method known to one of ordinary skill in the art.

The lighting module 100 may be dimensioned and shaped to substantially fit inside a container/enclosure or a lighting fixture (also referred to herein as “external housings”) to facilitate installation of the lighting module 100 in a variety of indoor or outdoor architectural settings. Examples of external housings include, but are not limited to, various electrical junction boxes, recessed lighting fixtures, surface mount lighting fixtures, step lighting fixtures, garden lighting fixtures, security lighting fixtures, tree lighting fixtures, ground lighting fixtures, and pathway lighting fixtures.

The external housing may include an open aperture to facilitate placement of the lighting module 100 in a cavity defined by the external housing. The open aperture may also vary in size (e.g., the characteristic length may range from about 3 inches to about 10 inches) and shape (e.g., circular, rounded square, polygonal). For example, FIG. 4A shows two exemplary implementations of electrical junction boxes 180, a 3.5 inch circular junction box and a 4 inch sized rounded square junction box, which may be used as an external housing for the lighting module 100. Knockouts (not shown) may also be included in the junction box to facilitate wiring and electrical connection to the lighting module 100, e.g., connector 128. FIGS. 4B-4F shows various views of an implementation of a lighting module 100 with dimensions that allow the lighting module 100 to fit in the junction boxes shown in FIG. 4A. The lighting module 100 may thus be interchangeable with different types and different sized external housings (and thus different lighting fixtures).

The lighting module 100 may be coupled to the external housing using a variety of coupling mechanisms, including, but not limited to, screw fasteners, bolt fasteners, clamps, retaining springs, and clips. For example, in implementations where the external housing is a junction box 180, the module housing 110 can include a plurality of holes 140 configured to align with a plurality of holes 182 on the junction box 180, as shown in FIG. 4G. Connecting members 142, e.g., screw fasteners, can thus be used to couple the module housing 110 to the junction box 180 through said holes 140 and 182. Generally, the dimensions of the holes 182 and the distance between the holes 182 can vary for different sized junction boxes 180. As a result, the holes 140 on the lighting module 100 may be aligned to one implementation of the junction box 180, but may not be aligned to another implementation of the junction box 180. To accommodate variations in the dimensionality of the junction box 180, an adapter 186 can be used, which can include a plurality of holes 187 that align with the holes 140 on the module housing 110 and a plurality of holes 188 that align with the holes 182 on the junction box 180, as shown in FIG. 4H. The adapter 186 can be disposed between the junction box 180 and the module housing 110 as shown in FIG. 4I. Connecting members 189, e.g., screw fasteners, can be used to couple the adapter 186 to the junction box 180 using holes 188 and 182. Connecting members 142, e.g., screw fasteners, can be used to couple the module housing 110 to the adapter 182 using holes 187 and 140. The adapter 186 can also include a central aperture dimensioned and shaped to such that the module housing 110 can substantially pass through said aperture for placement inside the cavity of the junction box 180. By dimensioning the lighting module 100 to fit inside a smaller junction box 180, e.g., a 3 inch diameter junction box, the same lighting module 100 can then be installed into larger junction boxes 180 using various adapters 186.

In some implementations, the external housing may be a recessed can housing. The lighting module 100 can be coupled to the recessed can housing using a plurality of retainer springs disposed on the trim 190 coupled to the lighting module 100. The retainer springs can be configured to apply an outward force on the interior surface of the cavity in the recessed can housing to secure the lighting module 100 to the recessed can housing. The same trim 190 coupled to the lighting module 100 can be used for various sized recessed can housings so long as the outward force applied by the retainer spring is sufficient to hold the lighting module 100 in the recessed can housing. For larger recessed can housings, a different trim 190 can be coupled to the same lighting module 100 to ensure the lighting module 100 is securely coupled to the larger recessed can housing.

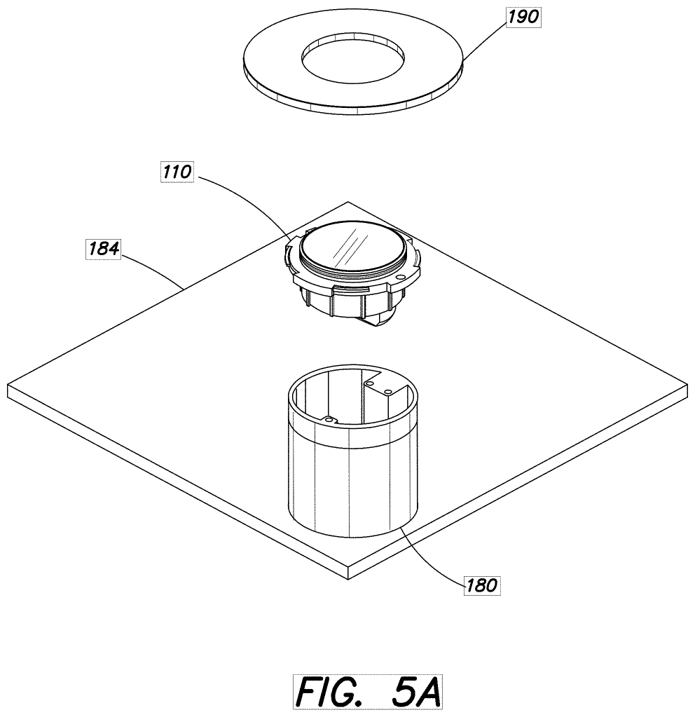

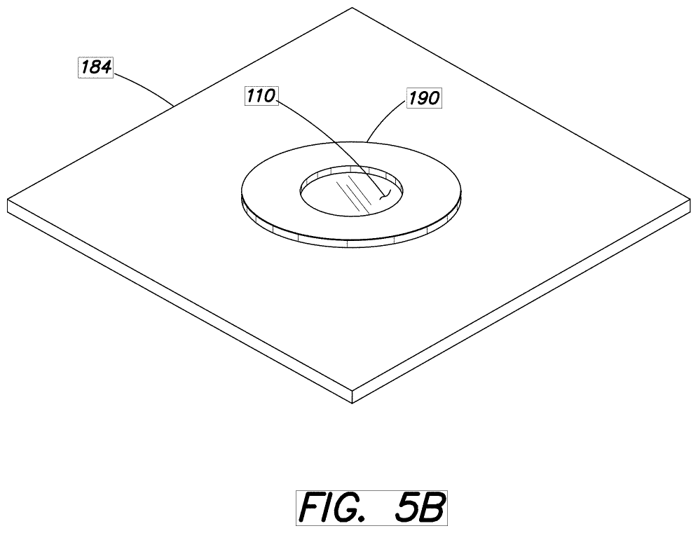

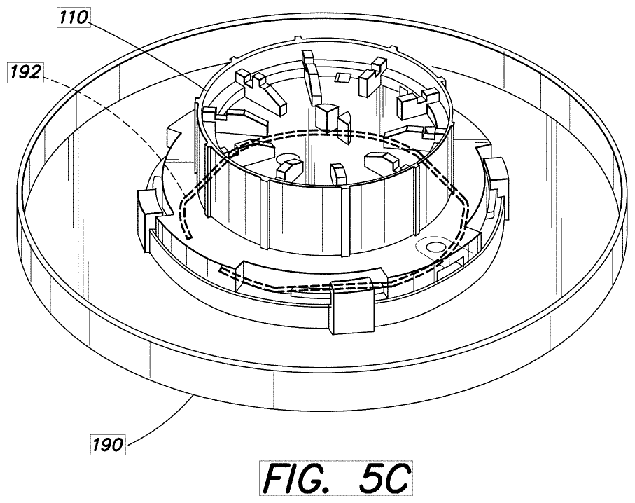

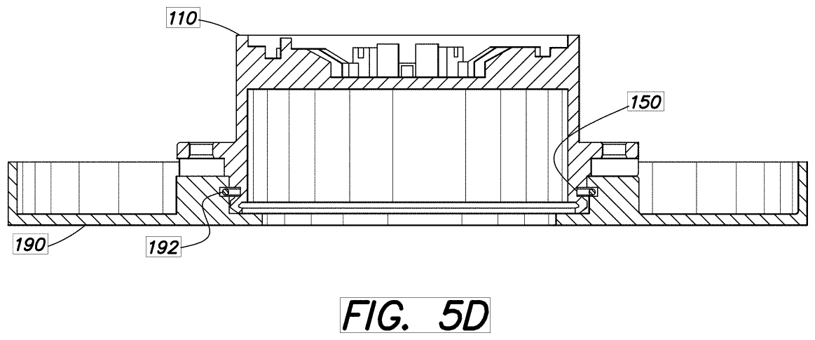

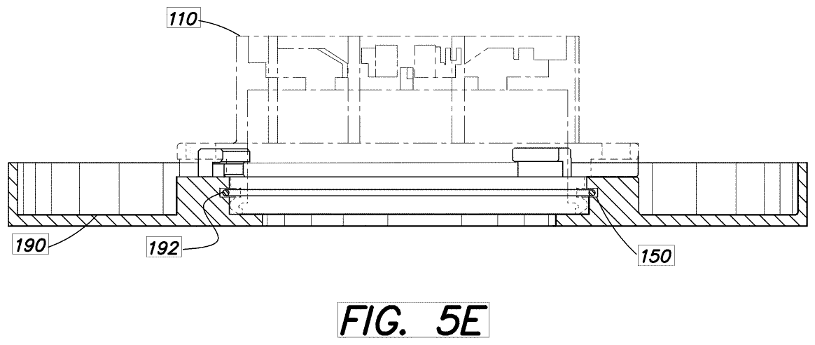

As described above, the lighting module 100 may also couple to the trim 190. The trim 190 is used to cover an exposed edge of a hole on a surface, e.g., a ceiling or a wall, where the lighting module 100 resides. The trim 190 can include an aperture to allow light from the lighting module 100 to pass through into the surrounding environment. For example, FIG. 5A shows an exemplary junction box 180 coupled to a surface 184. The junction box 180 defines a cavity where the lighting module 100 resides. The trim 190 can be coupled to the module housing 110 of the lighting module 100 such that the trim 190 covers the exposed edge of the cavity of the junction box 180 once assembled, as shown in FIG. 5B.

The trim 190 can be coupled to the lighting module 100 using a variety of coupling mechanisms, including, but not limited to, a twist-and-lock connector, magnets, a snap-in connector, molded snap features, screw fasteners, clips, clamps, resins, and adhesives. For example, FIGS. 5C-5E shows an implementation where a snap-in connector is used to couple the trim 190 to the module housing 110. As shown in FIG. 5D, the connecting member 192 on the trim 190 can include a groove along the interior sidewall of the aperture configured to hold a retaining spring. In some implementations, the retaining spring can be a wire-like element where portions of the retaining spring are configured to fit in a corresponding groove, e.g., connecting member 150, on the module housing 110 and apply an inwards force on the module housing 110 to securely couple the trim 190 to the module housing 110. In some implementations, the groove on the module housing 110 can be disposed along the exterior sidewall of the module housing 110 proximate to the front surface, as shown in FIG. 5D, to ensure the module housing 110 substantially fits in the cavity of the junction box 180.

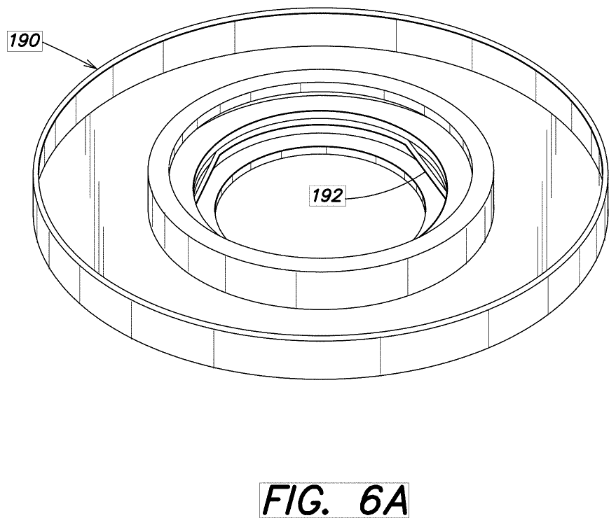

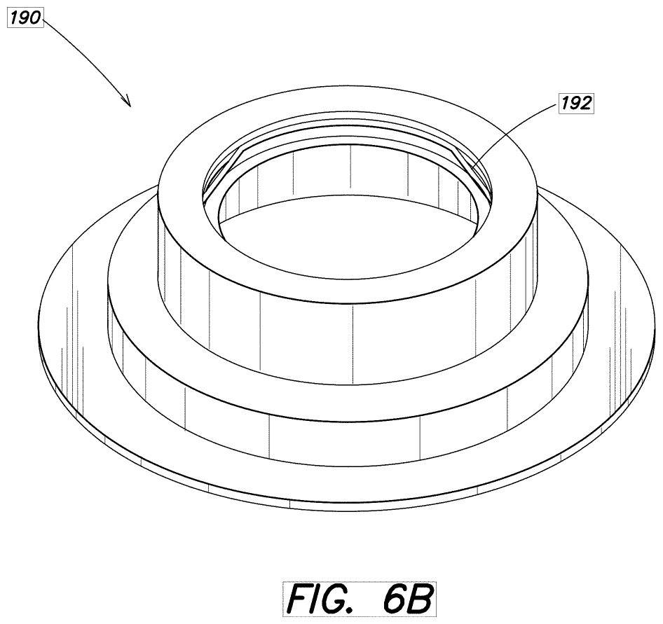

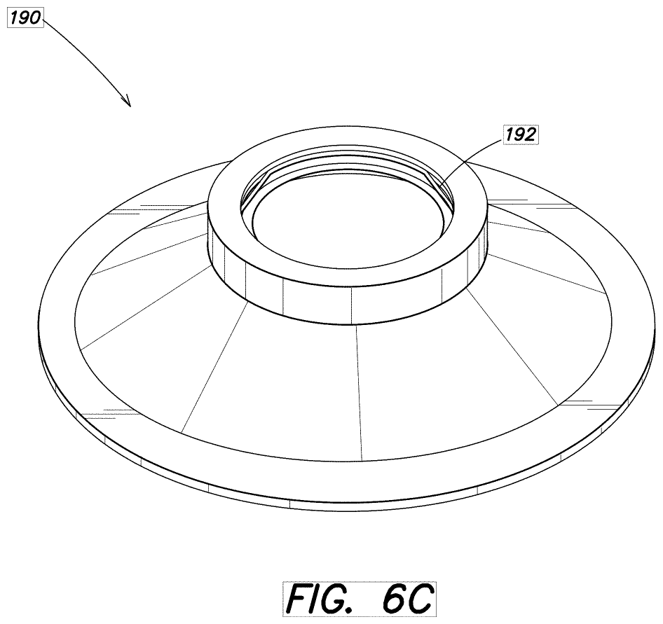

FIGS. 6A-6C show various implementations of the trim 190 with a retaining spring. FIG. 6A shows an implementation of the trim 190 where the front surface of the trim 190 is configured to be nearly coplanar with the front surface of the lighting module 100. FIG. 6B shows another implementation of the trim 190 where the front surface of the lighting module 100 is disposed inside a cylindrically recessed cavity defined by the trim 190. FIG. 6C shows another implementation of the trim 190 where the front surface of the lighting module 100 is disposed inside a conically recessed cavity defined by the trim 190.

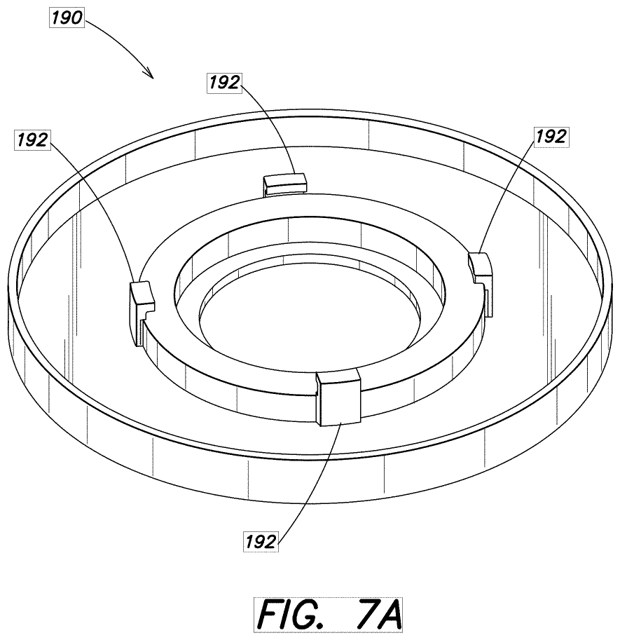

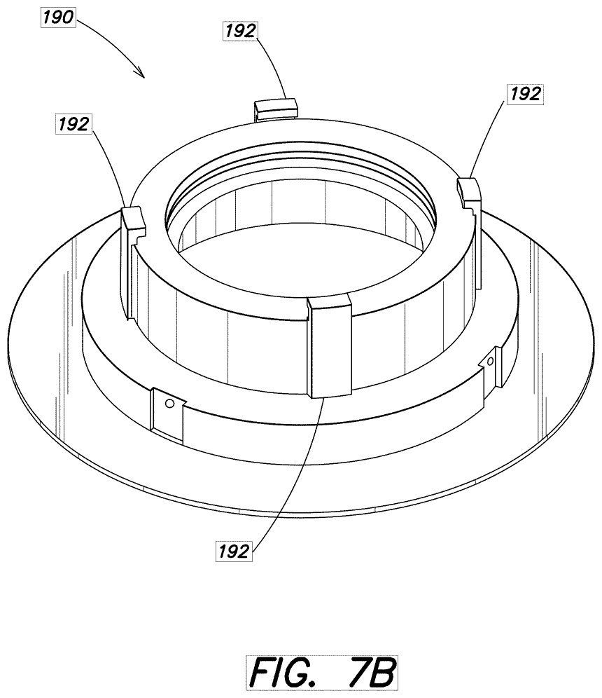

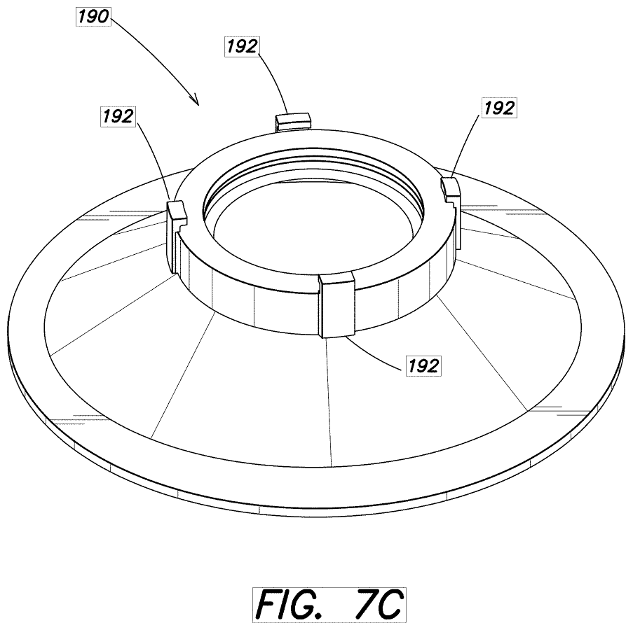

In some implementations, the trim 190 can be coupled to the module housing 110 via a twist-and-lock connector. The connecting members 150 on the module housing 110 can be a plurality of twist-and-lock flanges formed integrally with the module housing 110, as shown in FIG. 1A-1F. The connecting member 192 on the trim 190 can include a plurality of grooves or slots configured to couple to the twist-and-lock flanges on the module housing 110. FIGS. 7A-7C show various implementations of the trim 190 with a twist-and-lock connector. FIG. 7A shows an implementation of the trim 190 where the front surface of the trim 190 is configured to be nearly coplanar with the front surface of the lighting module 100. FIG. 7B shows an implementation of the trim 190 where the front surface of the lighting module 100 is disposed inside a cylindrically recessed cavity defined by the trim 190. FIG. 7C shows another implementation of the trim 190 where the front surface of the lighting module 100 is disposed inside a conically recessed cavity defined by the trim 190.

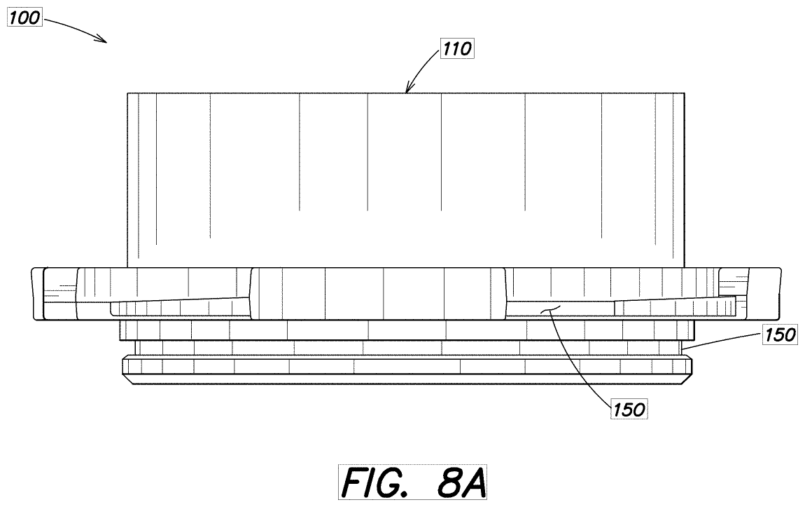

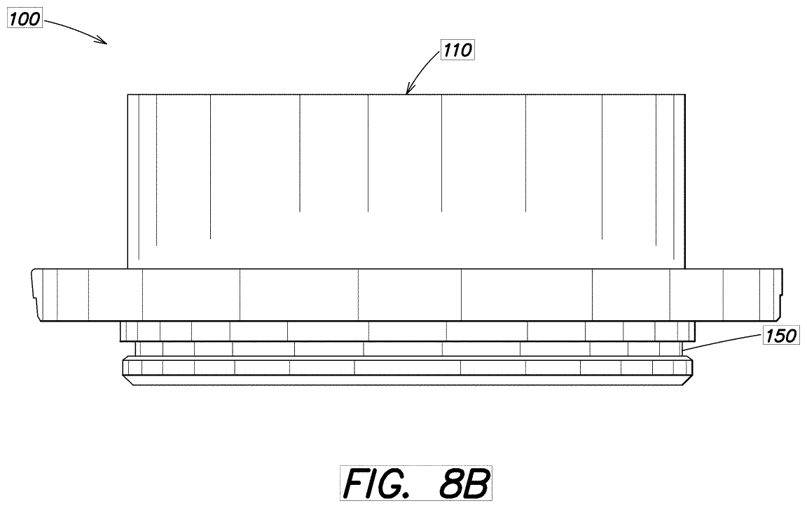

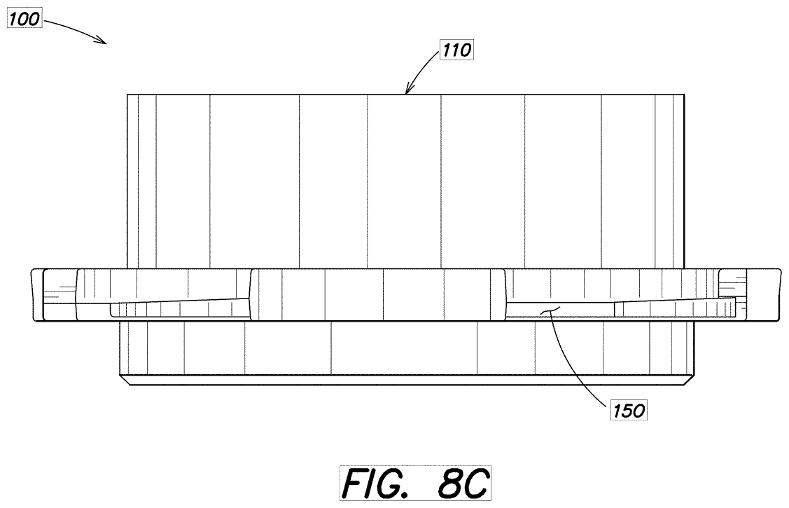

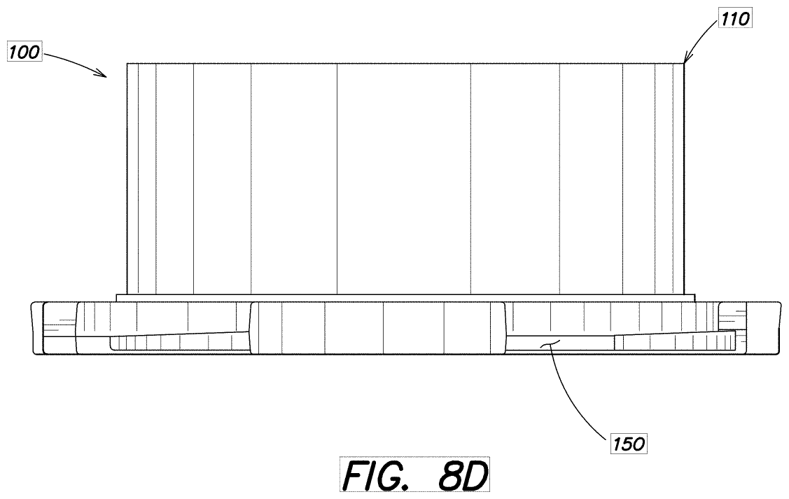

In some implementations, the module housing 110 may include one or more types of connecting members 150 to improve compatibility with a broader range of trim types. For example, FIG. 8A shows an implementation of the lighting module 100 where the connecting members 150 on the module housing 110 includes both a snap-in connector and a twist-and-lock connector. In some implementations, the module housing 110 may include only one type of connecting member 150. For example, FIG. 8B shows an implementation of a lighting module 100 where the connecting member 150 on the module housing 510 is a snap-in connector. FIG. 8C shows another implementation of a lighting module 100 where the connecting member 150 on the module housing 110 is a twist-and-lock connector disposed at a distance proximate to the front surface of the module housing 110. FIG. 8D shows another implementation of a lighting module 100 where the connecting member 150 on the module housing 110 is a twist-and-lock connector that is coplanar with the front surface of the module housing 110.

### Second Examples of a Lighting Module with an Integrated Electrical Connector

In a second set of examples presented below, lighting modules are disclosed that include one or more of the following features: an electrical connector integrated in a housing of the lighting module; LED light sources arranged along an interior sidewall of the housing of the lighting module and positioned so as to edge-light an optic (e.g., light guide) of the lighting module; and a lighting module housing configured to facilitate mechanical coupling of a trim to the lighting module via one or more snap-fit mechanisms (e.g., using pressure-deformable snap tabs on the trim that grab onto the housing).

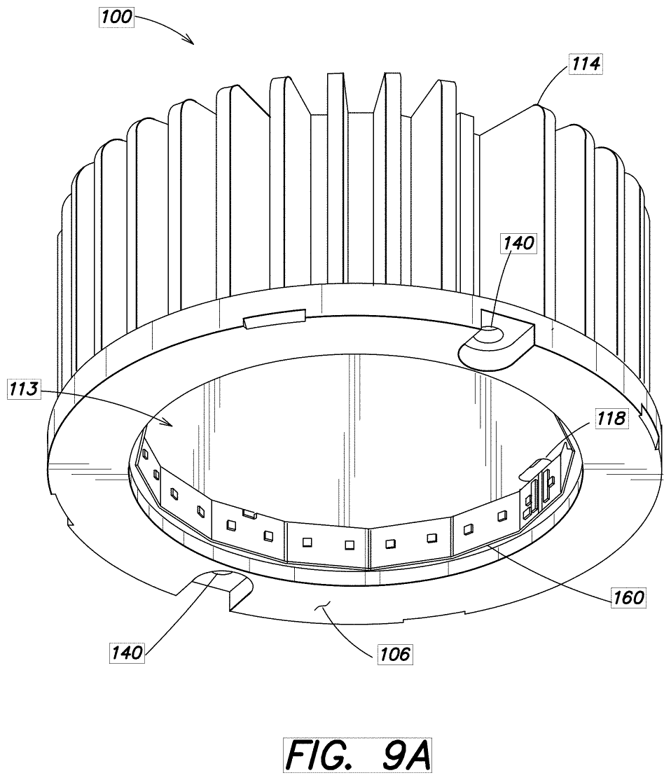

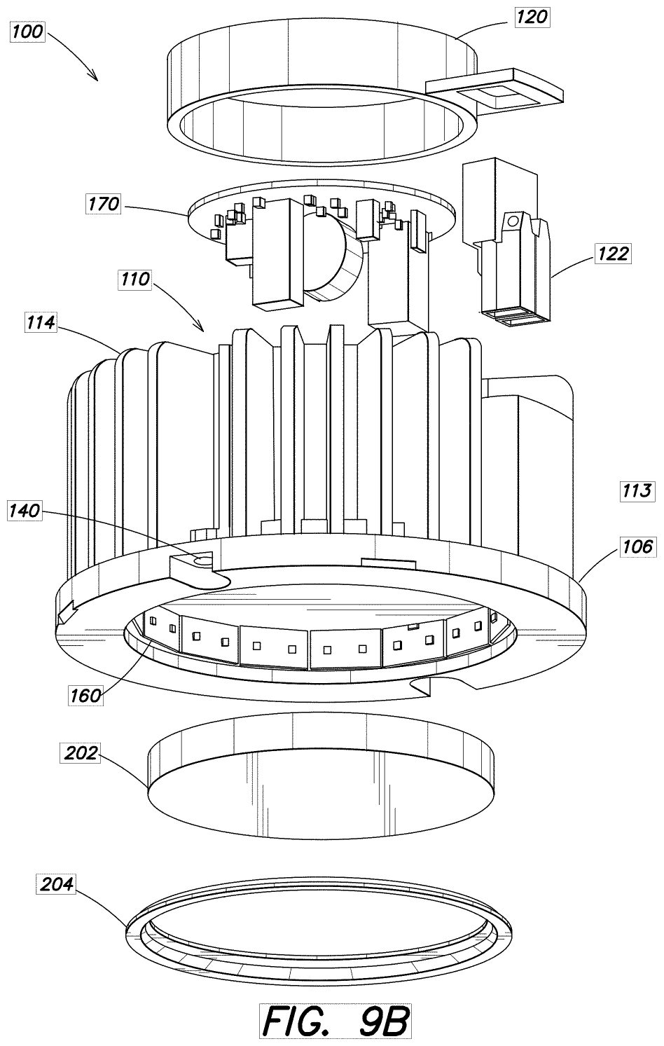

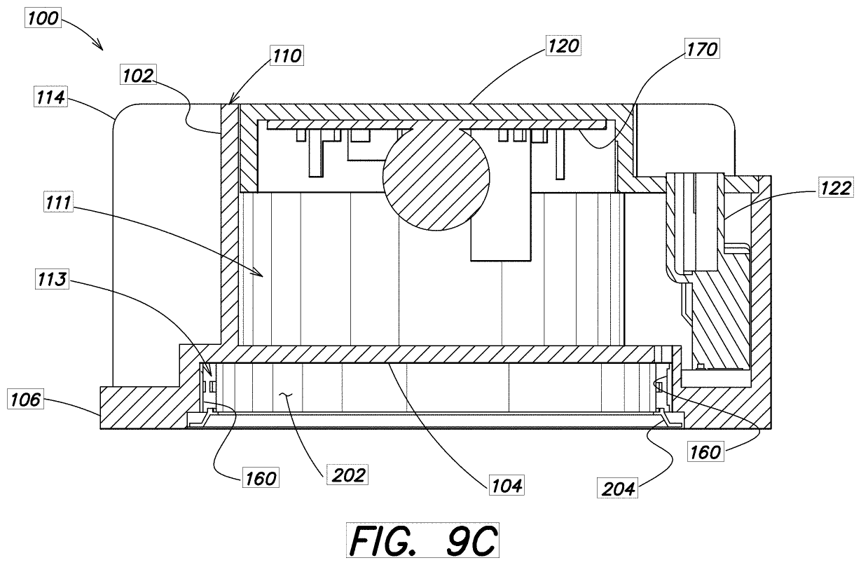

FIGS. 9A-9C show another exemplary implementation of the lighting module 100. As shown, the lighting module 100 may include a module housing 110 that is used, in part, to support and mount the various components of the lighting module 100. The module housing 110 may include two cavities, a cavity 113 to contain a light source 160 and a back cavity 111 to contain a driver 170. The cavities 111 and 113 may be defined by a sidewall 102 and separated by a partition 104 formed into the module housing 110. The cavity 113 may have an opening that allows light from the light source 160 to be emitted out of the lighting module 100. The cavity 111 may have an opening sufficiently large enough to allow the driver 170 to be placed into the cavity 111. The cavity 111 may be enclosed and, in some instances, substantially sealed using a back cover 120. Additionally, the lighting module 130 may include an electrical connector 122, electrically coupled to the driver 170, to receive electricity from an external power source (e.g., an AC voltage from the electrical system of a building). The lighting module 100 may also include an optic 202 to increase the light coupling efficiency of the lighting module 100 and to shape the light to provide a desired beam profile (e.g., a desired angular distribution, a desired spatial distribution). It should be appreciated the various features, structures, and materials described with respect to the lighting module 100 depicted in FIGS. 1A-1F may also be applied to the lighting module 100 shown in FIGS. 9A-9C.

The module housing 110, as described above, is primarily used to support the various components of the lighting module 100 and to define the cavities 111 and 113 that contain the driver 170 and the light source 160, respectively. The depth of the cavities 111 and 113 as defined by the sidewall 102 may depend on the respective dimensions of the driver 170 and the light source 160. The depth of each cavity may be chosen to increase the distance and, hence, the thermal resistance (e.g., a combination of the air gap resistance and the sidewall resistance between the driver 170 and the light source 160) between the driver 170 and the light source 160. A larger thermal resistance reduces unwanted temperature increases in the driver 170 caused by heat generated by the light source 160, thus increasing the lifetime of both the driver 170 and the light source 160. However, the depth of each cavity may be limited by size constraints imposed on the lighting module 100, which may be dictated by the largest compatible lighting module 100 that can fit into a particular external housing of a lighting fixture. To this end, a shallower depth may be attainable with the aide of various heat dissipation features integrated into the module housing 110, which may divert heat from the light source 160 away from the driver 170.

For example, FIGS. 9A and 9B show the module housing 110 having a plurality of heat fins 114 disposed along the exterior surface of the sidewall 102. The heat fins 114 may be used to dissipate heat convectively to the surrounding air. Additionally, the module housing 110 may include a flange 106 located along the opening to the cavity 113. The flange 160 may be used, in part, to interface with a trim 190. As described above, the trim 190 may also be used to dissipate heat from the module housing 110 by conducting heat through the portion of the trim 190 in contact with the module housing 110. In order to increase heat transfer, the flange 160 may be designed to have a larger surface area through which heat may be conducted to the trim 190. The flange 160 may also provide a coupling mechanism that imposes a force between the flange 160 and the trim 190 that increases thermal contact.

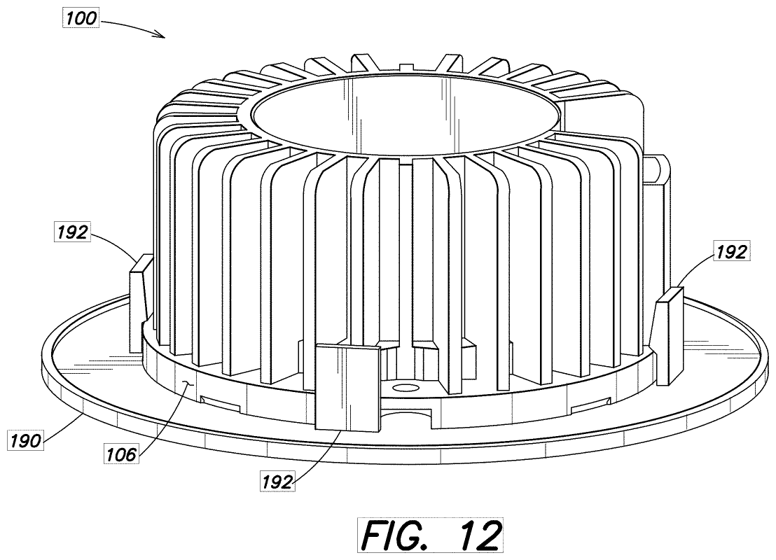

In the exemplary module housing 110 depicted in FIGS. 9A-9C, the flange 160 incorporates molded snap features designed to accommodate snap connectors 192 on the trim 190, as shown in FIG. 12. As shown, the snap connectors 192 may mate to a ledge along the perimeter of the flange 160. The snap connectors 192 may be designed to retain the trim 190 to the module housing 110 with a holding force that also increases thermal contact. The molded snap feature may be used particularly when the module housing 110 and the trim 190 are formed from a material with sufficient tensile strength, such as a hard plastic or even a metal. The use of snap features is desirable in that the trim 190 and/or the module housing 110 (particularly in the case where an overmolding process is used) may thus be formed from a single piece, which reduces assembly, labor, and part costs.

In some implementations, one or more venting holes (not shown) may be disposed on the sidewall 102 proximate to the cavity 113 and the light source 160. The one or more venting holes may allow air heated by the light source 160 to pass through from the cavity 113 into the surrounding ambient environment. The flow of heated air may be driven by convective currents caused by temperature gradients within the air in the cavity 113 and with respect to the surrounding air around the lighting module 110. The quantity, size, and locations of the one or more venting holes may be dictated by potential light leaks through the one or more venting holes. Light leaks may reduce the light coupling efficiency of the lighting module 100 and may also lead to undesirable aesthetics, particularly if the light leaks out through another opening in the lighting fixture (e.g., a separate hole in the wall or ceiling).

The partition 104 may include a feedthrough 160 to route a wire (not shown) between the cavities 111 and 113. The wire may be used to electrically couple the light source 160 and the driver 170 together. The feedthrough 160 may be dimensioned to have similar dimensions to the wire and/or may be filled with a grommet surrounding the wire or a filler material such as an adhesive, a paste, or an epoxy. In this manner, the cavities 111 and 113 may remain substantially isolated from one another. By keeping the cavities 111 and 113 separate, potential issues related to moisture accumulation are less likely to affect both the light source 160 and the driver 170.

The module housing 110 may also include coupling features to facilitate coupling of the lighting module 100 to an external housing of a lighting fixture. For example, FIGS. 9A-9C show the module housing 110 as having holes 140, which align to corresponding holes on an electrical junction box. The holes 140 may receive a screw fastener to bolt the lighting module 100 to the external housing. It should be appreciated, however, that other coupling features may be used including, but not limited to a twist and lock mechanism, snap fit connectors, and retention springs.

In some implementations, the module housing 110 may be formed from various thermally conductive materials including, but not limited to a metal such as aluminum, steel, and copper, or a thermally conductive polymer such as a Markrolon® polycarbonate or a Therma-Tech™ thermally conductive compound. The module housing 110 generally be formed from a material having a thermal conductivity greater than at least 0.5 W·m⁻¹K⁻¹. In some implementations, the module housing 110 may be formed entirely from a metal or a thermally conductive polymer depending on acceptable costs and/or thermal performance.

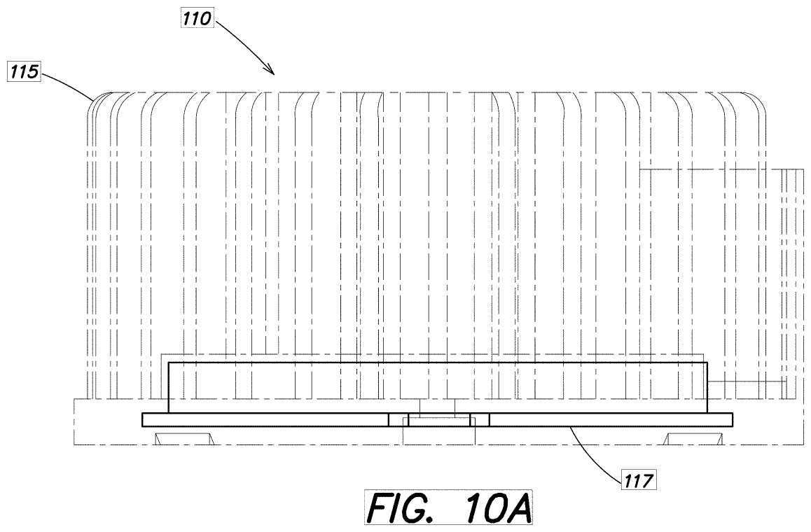

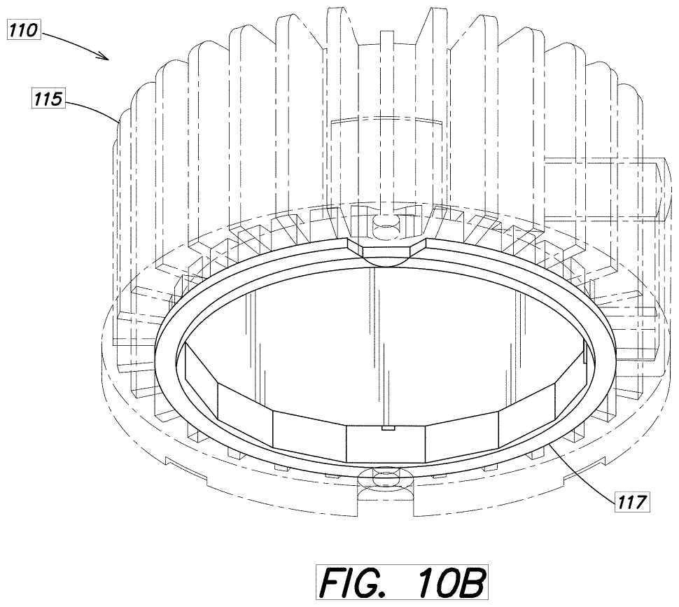

In some implementations, the module housing 110 may be formed as two parts using an overmolding process where an overmold is formed around a base part via casting, injection molding, or a similar process. FIGS. 10A and 10B show an exemplary module housing 110 fabricated using the overmolding process. As shown, the module housing 110 may include a base 117 and an overmold 115. The base 117 may be used, in part, to dissipate heat from the light source 160. As such, the light source 160 may be coupled to an exposed surface of the base 117 for direct thermal contact. A thermally conductive epoxy, adhesive, or paste may be used to mount the light source 160 to the base 117. However, in cases where the base 117 is electrically conductive, such as a metal, it is desirable to reduce the exposed surface area of the base 117 in order to reduce possible hazards associated with electrical shock. The overmold 115, which may be formed from a thermally conductive, yet electrically insulating material, may thus be used to cover the exposed surfaces of the base 117 such that the likelihood of a user touching an exposed surface of the base 117 is substantially reduced.

In FIGS. 10A and 10B, the base 117 is depicted as defining a part of the sidewall 102 and the first cavity 113 of the lighting module 110. The overmold 115 may define the remaining portion of the first cavity 113, the second cavity 111, the partition 104, and any other heat sink related features on the module housing 110. Thus, the base 117 has two exposed surfaces: a portion of the sidewall 113 onto which the light source 160 is mounted to and a portion of the partition 104. These exposed surfaces may be covered by other components in the lighting module 100 when fully assembled. In some implementations, the overmold 115 may sufficiently electrically insulate the lighting module 100 such that a separate electrical ground for the lighting module 100 can be eliminated. Furthermore, the use of an overmolding process may allow for greater bonding between the overmold 115 and the base 117, thus reducing thermal resistances within the module housing 110. However, it should be appreciated in other implementations, the module housing 110 may be formed from two parts using a different assembly process. For example, a corresponding “overmold” and “base” may be assembled using conventional fasteners in combination with a thermal grease or adhesive disposed at the interface(s) between the parts.

It should be appreciated that in other implementations, the overmold 115 may fully cover all surfaces of the base 117 (e.g., the base 117 is embedded into the overmold 115) or allow one or more than two surfaces of the base 117 to be exposed. It should also be appreciated that in other implementations, the relative proportions of the module housing 110 formed of the base 117 and the overmold 115 may also change. For example, the base 117 may define the second cavity 111, the plurality of fins 114, and the various coupling features to couple the lighting module 100 to an external housing of a lighting fixture or to couple at trim 190 to the lighting module 100.

The base 117 may be a thermally conductive material (e.g., having a thermal conductivity greater than about 0.5 W·m⁻¹K⁻¹), such as a metal, formed using various sheet metal, machining, or casting processes. The overmold 115 may also be a thermally conductive material (e.g., having a thermal conductivity greater than about 0.5 W·m⁻¹K⁻¹), such as a thermally conductive polymer.

The driver 170 may be mounted to the back cover 120 to better thermally separate the light source 160 from the driver 170. As shown, the driver 170 may be mounted in an inverted manner to the back cover 160. This may be accomplished by mounting the driver 170 to the back cover 120 using various coupling mechanisms including, but not limited to screw fasteners, adhesives, or a press fit. In some implementations, the back cover 120 may be a cup-shaped component that partially encloses the driver 170 as shown in FIG. 9C. The back cover 120 may thus be used to partially insulate the driver 170 from the other components in the lighting module 100, further reducing the risk of electric shock hazards. The driver 170 may also have a structural feature that retains the electrical connector 122 into the module housing 110. As shown, the back cover 120 may have an opening that matches the shape of the electrical connector 122. As described above, the back cover 120 may be coupled to the module housing 110 using various coupling mechanisms including, but not limited to screw fasteners, snap fit connectors, or adhesives.

The lighting module 100 may also include the connector 122 to facilitate electrical coupling between the lighting module 100 and an external power source (e.g., an AC voltage from the electrical system of a building). As shown in FIGS. 9A-9C, the module housing 110 may be shaped such that the electrical connector 122 may be substantially nested within the outer boundaries of the module housing 110, thus providing a lighting module 100 with a smaller overall form factor. The electrical connector 122 may be various types of connectors including, but not limited to a 2-pin connector and a 3-pin connector.

The electrical connector 122 depicted in FIGS. 9A-9C may be a multi-pin connector with an integrated return path. For example, the connector may include the ground and can be a 3-pin male, 2-pin female with a metal contact to the housing 110, or a 3-pin female with internal ground. In one example the connector is a 2-pin connector where each pin corresponds to a positive and a negative terminal. The 2-pin connector may include an external ground that contacts a metallic portion of the module housing 110 via an exposed contact and a strategically designed metal pin. The 2-pin connector may thus provide similar functionality to 3-pin connector at lower costs and with a smaller form factor. Furthermore, by providing an integrated ground to the lighting module 100 in this manner, a wire nut/wire and/or another connection between the lighting module 100 and the external housing of the lighting fixture further simplifying installation. Examples of an electrical connector that may be employed as the electrical connector 122 include, but are not limited to, the Ideal Powerplug° luminaire disconnect model 182 series connectors.

The light source 160 may include multiple light emitting elements that each emit light and are each operably coupled to the driver 170. The light emitting elements may each be supported by a printed circuit board (PCB) or a flexible circuit board (FCB). For example, the light emitting elements may be in the form of a flexible roll that is sufficiently compliant to conform with the cross-sectional shape of the cavity 113. In some implementations, the light emitting elements may be disposed in various locations in the cavity 113. For example, FIGS. 9A and 9B show the light source 160 mounted onto the sidewall 102 such that the light emitting elements are uniformly distributed along the sidewall 102 and oriented perpendicular to the driver 170. In other implementations, the light emitting elements may be concentrated to one portion of the sidewall 102 and/or may be non-uniformly distributed along the sidewall 102. In some implementations, the light emitting elements may be disposed on the partition 104 or a combination of the sidewall 102 and the partition 104.

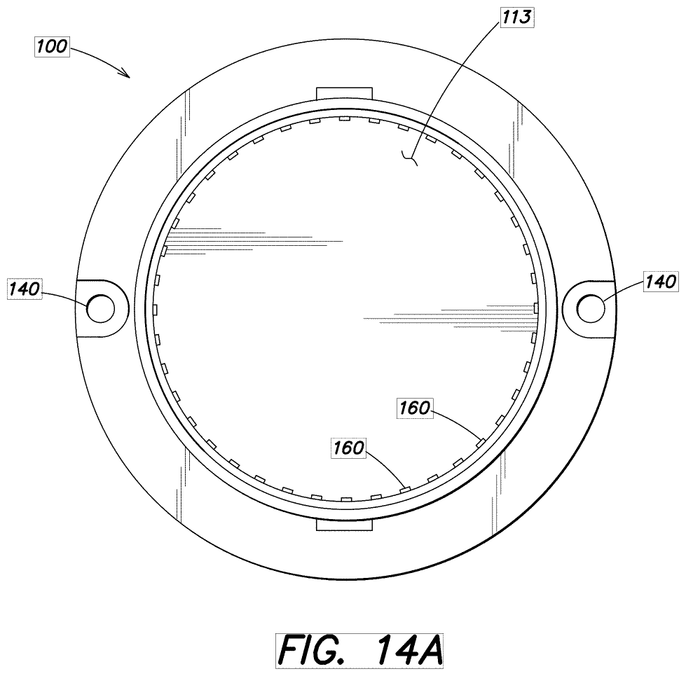

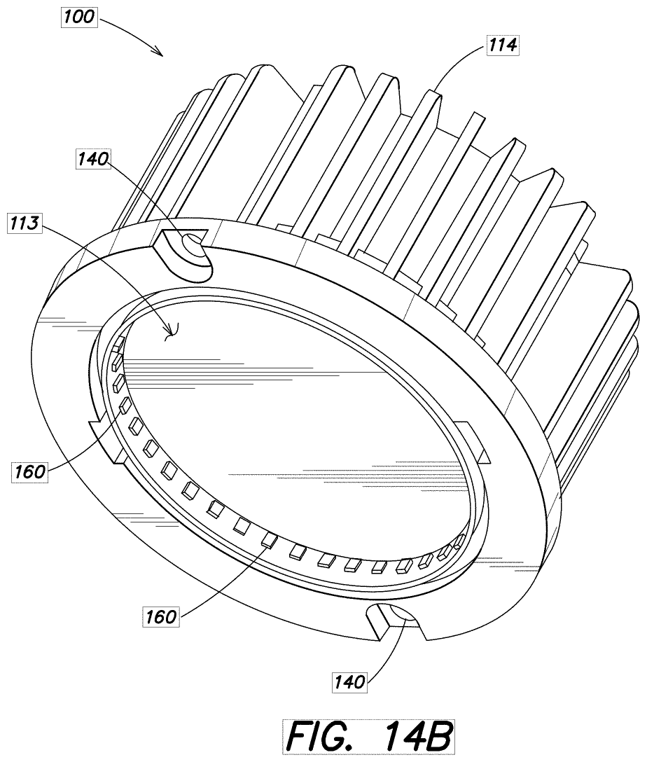

In some implementations, the cross-sectional shape of the cavity 113 may be a polygon. For example, FIGS. 9A and 9B show the cavity 113 as being a 16-sided polygon. A polygonal cross-section may enable easier assembly of the light source 160 to the module housing 110 by providing flat surfaces to mount the light emitting elements of the light source 160. A polygonal cross-sectional shape may also allow for greater ease in the design and alignment of the optic 202 to the light source 106 by providing a discrete number of well-defined surfaces (e.g., a surface with a known flatness and orientation) from which light is emitted into the optic 202. It should be appreciated that the cavity 113 may have other cross-sectional shapes including, but not limited to an asymmetric polygon, a circle, and an ellipse. For example, FIGS. 14A and 14B show another exemplary lighting module 100 where the cavity 113 has a circular cross-section. The light emitting elements of the light source 160 are disposed along the sidewall 102 defining the circular cavity 113.

In the case where the light emitting elements of the light source 160 are mounted on the sidewall 102 of the cavity 113, light emitted by the light emitting elements will be directed towards the center (or some interior location within the cavity 113) as opposed to being directed out of the lighting module 100. The optic 202 disposed within the cavity 113 may thus be used to redirect light emitted by the light source 160 out of the lighting module 100. In some implementations, the optic 202 may be tailored to output light as a beam with desired properties (e.g., a desired angular distribution, a desired spatial distribution, a desired chromatic dispersion).

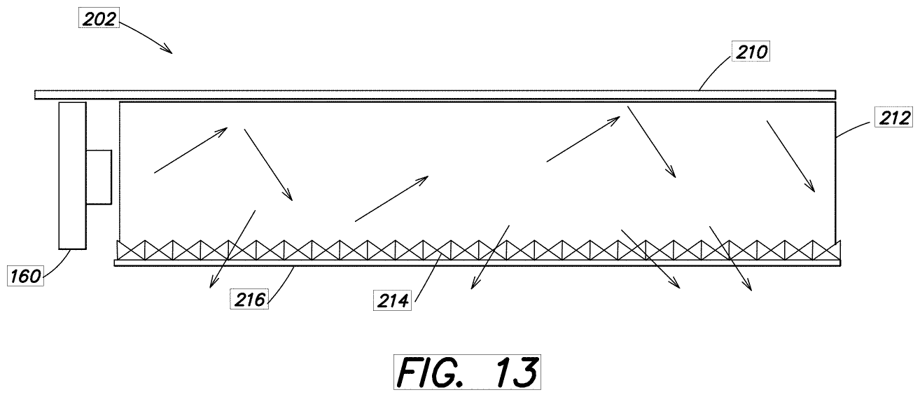

FIG. 13 shows one exemplary optic 202 that includes a light guide 212, a reflector 210, and an outcoupler 214. The light guide 212 is used to receive light emitted by the light source 160 at the edge of the optic 202 as shown. Once the light is coupled into the light guide 212, the light propagates along the light guide 212 away from the edge where the light coupled into the light guide 212 (i.e., towards an opposing edge of the optic 202). The reflector 210, which may be disposed directly onto the light guide 212 on a surface facing towards the partition 104 (i.e., away from the opening of the cavity 113) may be used to prevent light from leaking out of the light guide 212 and, hence, being absorbed or otherwise redirected along a direction that is not desirable within the cavity 113. In some implementations, the reflector 210 may be a material with a refractive index lower than the light guide 212 such that total internal reflection occurs at the interface (e.g., similar to a core and a cladding in an optical fiber).

The outcoupler 214, which may be disposed directly onto the light guide 212 on a surface facing towards the opening of the cavity 113, may be used to couple out light from the light guide 212 and thus, the lighting module 100. The outcoupler 214 may couple out light in a controlled manner that leads to the generation of a beam with the desired properties described above. This may be accomplished, in part, by the outcoupler 214 being a structured surface of the light guide 212. For example, the outcoupler 214 may be a series of prismatic microstructures formed directly onto the light guide 212. The shape and size of the microstructures may vary as a function of the location along the surface of the light guide 212. In some implementations, the outcoupler 214 may be designed based on a particular light emission profile of the light source 160 and position of the optic 202 with respect to the light source 160.

An optical film 216 with suitably designed extraction patterns may also be disposed on the outcoupler 214. The film 216 may further modify the beam profile of the light coupled out of the light guide 212. For example, the film 216 may be a diffuser that disperses and softens the light coupled out of the lighting module 100. In another example, the film 216 may be a filter that removes unwanted wavelengths from the light source 160. Generally speaking, the film 216 may facilitate reduction of glare, alter beam pattern of the light coupled out of the lighting module, and mask out artifacts of the light sight source.

The optic 202 as depicted in FIG. 13 may thus have a form factor similar to a plate or a sheet. Thus, the optic 202 may have a comparatively smaller thickness than a conventional chip on board (COB) light source 160 and a reflector configuration. This allows for a shallower cavity 113 and, hence, a reduction in the overall size of the lighting module 100.

The light guide 212 and the reflector 210 may be formed from various materials depending on the desired operating wavelength of the light source 160 including, but not limited to polymethyl methacrylate (PMMA), polycarbonate, silicon dioxide, borosilicate glass, magnesium fluoride, and calcium fluoride. In some implementations, the complex refractive index of the light guide 212 and the reflector 210 may be modified by introducing dopants into the material.

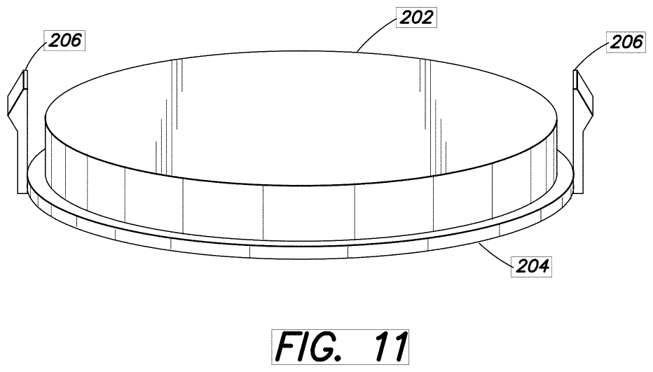

The optic 202 may be mounted to the module housing 110 using a retaining ring 204. The retaining ring 204 may be coupled to the module housing 110 using various coupling mechanisms including, but not limited to a screw fastener, a twist and lock mechanism, a snap fit connector, or an adhesive. FIG. 11 shows on exemplary retaining ring 204 supporting the optic 202. As shown, the retaining ring 204 has two snap fit connectors 206 that are designed to couple to the interior sidewall 102 in the cavity 113. The use of snap fit connectors 206 may allow users to remove and replace the optic 202 after the lighting module 100 is installed without the use of any additional tools. In some implementations, different optics 202 may provide different beam profiles (e.g., a wider or narrower beam focus). Rather than having to replace the entire lighting module, a user can instead replace the optic 202 in the field by removing and/or securing the retaining ring 204, thus providing greater flexibility and ease of use for the user.

### Example Lighting Fixture Configurations Including Lighting Modules

Any of the inventive lighting module examples discussed above may be employed in a variety of different lighting fixture configurations and/or inserted within a container/enclosure (e.g., an electrical junction box) for a variety of different architectural applications.

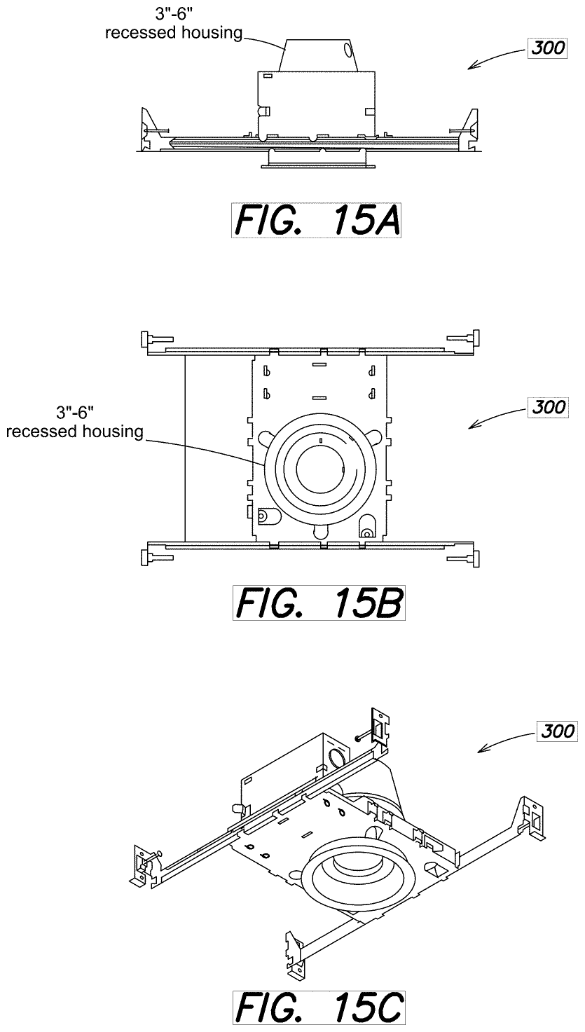

For example, FIGS. 15A, 15B and 15C show respective side, bottom, and perspective views of a recessed lighting fixture 300 including a lighting module according to the various implementations illustrated and described herein.

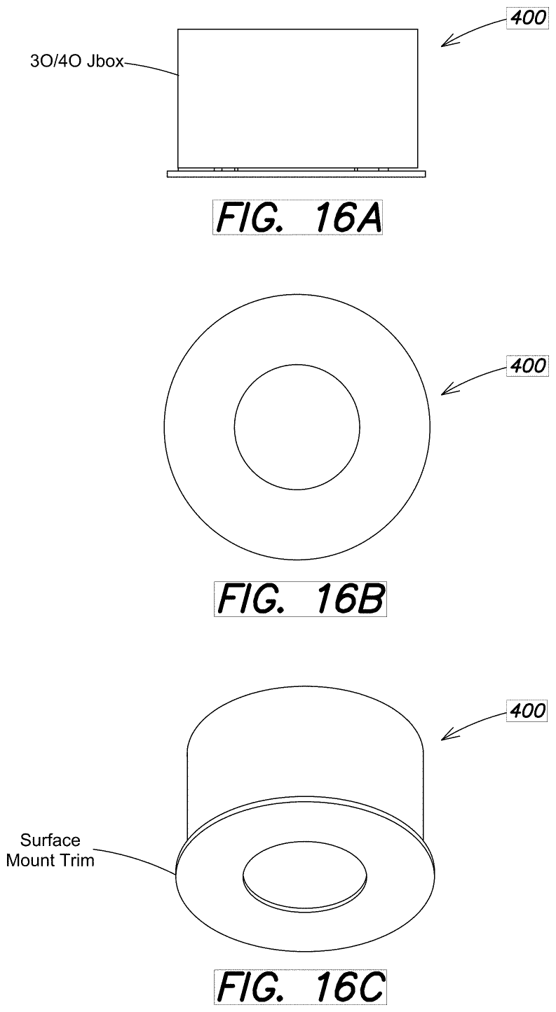

FIGS. 16A, 16B and 16C show respective side, bottom, and perspective views of a lighting module according to the various implementations illustrated and described herein, disposed in a junction box and coupled to a surface mount trim in a surface mount lighting configuration 400.

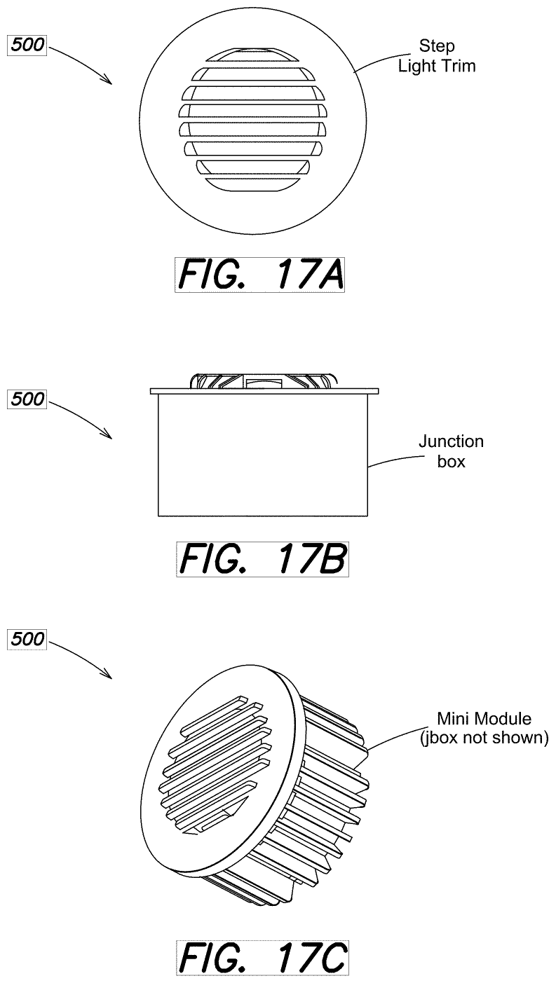

FIGS. 17A, 17B and 17C show respective front, side, and perspective views of a lighting module according to the various implementations illustrated and described herein, disposed in a junction box and coupled to a step light trim in a step light configuration 500.

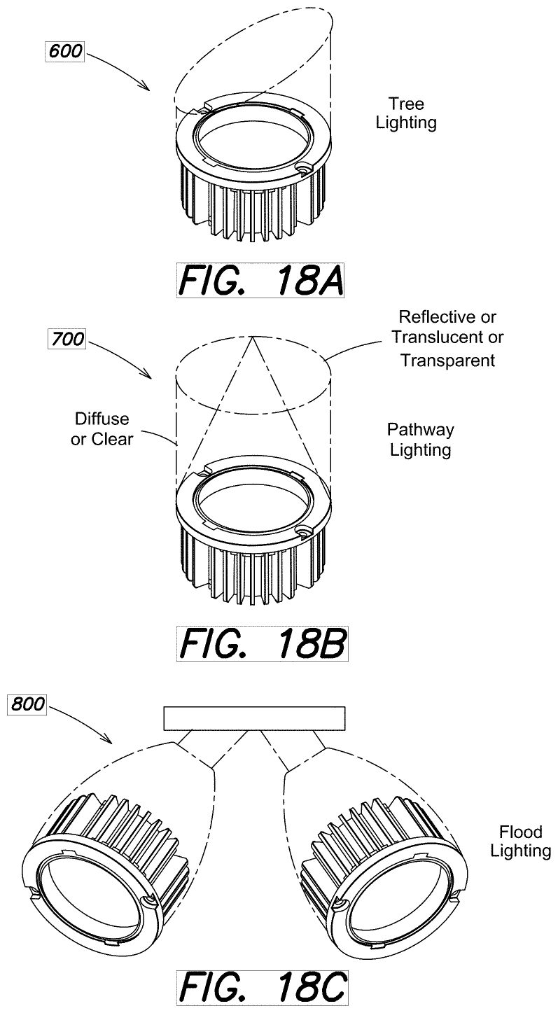

FIGS. 18A, 18B and 18C illustrate a lighting module according to the various implementations illustrated and described herein, disposed in a tree lighting fixture 600, a pathway lighting fixture 700, and a flood lighting fixture 800, respectively.

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A lighting module, comprising:
a module housing, comprising:
a sidewall; and
a partition coupled to the sidewall such that the partition and the sidewall together define a first cavity and a second cavity;
a light source, disposed within the first cavity, to emit light;
a back cover directly coupled to the module housing and at least partially disposed within the second cavity so as to enclose the second cavity, the back cover being a cup-shaped component formed of plastic; and
a driver, mounted directly to the back cover and disposed within the second cavity, to supply electricity to power the light source, the driver being at least partially insulated from the module housing via the back cover.

2. The lighting module of claim 1, wherein:
the sidewall includes a backside edge abutting the second cavity; and
the back cover is substantially flush with the backside edge.

3. The lighting module of claim 1, wherein the back cover is coupled to the module housing via one or more snap-fit connectors.

4. The lighting module of claim 1, wherein the module housing further comprises a flange, abutting the first cavity, having at least one of a twist-and-lock connector or a snap-in connector to couple a trim to the module housing.

5. The lighting module of claim 4, further comprising:
the trim, coupled to the module housing, via the at least one of a twist-and-lock connector or a snap-in connector.

6. The lighting module of claim 5, wherein the at least one of a twist-and-lock connector or a snap-in connector imposes a force between the flange and the trim to increase thermal contact.

7. The lighting module of claim 1, wherein the lighting module is dimensioned to fit into an enclosure having an interior width dimension less than 3.5 inches.

8. The lighting module of claim 1, wherein the module housing further comprises:
a flange having a pair of openings that are arranged to align with corresponding openings of an enclosure when the lighting module is inserted into the enclosure, the pair of openings being separated by a distance of about 70 mm.

9. The lighting module of claim 1, further comprising:
a retaining ring, coupled to the module housing via one or more snap-fit connectors and disposed within the first cavity so as to cover at least a portion of the first cavity, the retaining ring being substantially flush with a frontside edge of the sidewall of the module housing.

10. The lighting module of claim 9, further comprising:
an optic, disposed within the first cavity and supported by the retaining ring, to redirect light emitted by the light source.

11. A lighting module, comprising:
a module housing, comprising:
a partition having a rear exterior surface and a rear interior surface; and
a sidewall, coupled to the partition, defining a first cavity that abuts the rear interior surface, the sidewall extending past the partition and surrounding a backside section, the backside section abutting the rear exterior surface of the partition and being separated from the first cavity by the partition;
a back cover directly coupled to the module housing and at least partially disposed within the backside section so as to substantially cover the backside section, the back cover defining a second cavity, the back cover being formed of plastic;
a light source, disposed within the first cavity, to emit light; and
a driver, coupled to the module housing, to supply electricity to power the light source.

12. The lighting module of claim 11, wherein the driver is directly mounted to the back cover and at least partially disposed within the second cavity.

13. The lighting module of claim 12, wherein the driver is at least partially insulated from the module housing via the back cover.

14. The lighting module of claim 11, wherein:
the sidewall includes a backside edge abutting the backside section; and
the back cover is substantially flush with the backside edge.

15. The lighting module of claim 11, further comprising:
a trim, coupled to the module housing via a connecting member, to cover a hole of a ceiling or a wall when the lighting module is installed into the ceiling or the wall and to dissipate heat from the module housing, the connecting member imposing a force between the flange and the trim to increase thermal contact.

16. The lighting module of claim 15, wherein the connecting member comprises at least one of a twist-and-lock connector or a snap-in connector.

17. The lighting module of claim 11, wherein the lighting module is dimensioned to fit into an enclosure having an interior width dimension less than 3.5 inches.

18. The lighting module of claim 11, wherein the module housing further comprises:
a flange having a pair of openings that are arranged to align with corresponding openings of an enclosure when the lighting module is inserted into the enclosure, the pair of openings being separated by a distance of about 70 mm.

19. A lighting module, comprising:
a module housing formed of aluminum, the module housing comprising:
a sidewall having a backside edge, a frontside edge, and a plurality of fins;
a partition coupled to the sidewall such that the partition and the sidewall together define a first cavity and a second cavity, the second cavity abutting the backside edge; and
a flange having a pair of openings that are arranged to align with corresponding openings of an enclosure when the lighting module is inserted into the enclosure, the pair of openings being separated by a distance of about 70 mm;
a light source, disposed within the first cavity, having at least one light emitting diode (LED) to emit light;
a retaining ring coupled to the module housing via one or more snap-fit connectors and disposed within the first cavity so as to cover at least a portion of the first cavity, the retaining ring being substantially flush with the frontside edge of the module housing;
a back cover directly coupled to the module housing via one or more snap-fit connectors and enclosing the second cavity, the back cover being a cup-shaped component formed of plastic, the back cover being substantially contained within the second cavity such that no portion of the back cover extends beyond the backside edge of the module housing; and
a driver, mounted directly to the back cover and disposed within the second cavity, to supply electricity to power the light source, the driver being at least partially insulated from the module housing via the back cover.

20. The lighting module of claim 19, further comprising:
a trim, coupled to the module housing via at least one of a twist-and-lock connector or a snap-in connector, to cover a hole of a ceiling or a wall when the lighting module is installed into the ceiling or the wall and to dissipate heat form the module housing, the at least one of a twist-and-lock connector or a snap-in connector imposing a force between the flange and the trim to increase thermal contact.
